(19) United States
(12) Patent Application Publication
(10) Pub. No.: US 2026/0044269 A1
(43) Pub. Date: Feb. 12, 2026

(54) SYSTEM, METHOD, AND APPARATUS TO IMPLEMENT A SHARED STORAGE FOR END POINTS ON A VEHICLE

(71) Applicant: Sonatus, Inc., Sunnyvale, CA (US)

(72) Inventors: Yu Fang, Palo Alto, CA (US); Yixiang Chen, Palo Alto, CA (US); James Murphy, Alameda, CA (US); Jeffrey Chou, Palo Alto, CA (US)

(21) Appl. No.: 19/364,984

(22) Filed: Oct. 21, 2025

Related U.S. Application Data
(63) Continuation of application No. PCT/US2025/010490, filed on Jan. 6, 2025.
(60) Provisional application No. 63/618,612, filed on Jan. 8, 2024.

(51) Int. Cl. G06F 3/06

(52) U.S. Cl. CPC G06F 3/0622; G06F 3/0655; G06F 3/067

(57) ABSTRACT

A system may include a plurality of network shared storage (NSS) client managers associated with a respective plurality of share entities in the vehicle. The system may include an NSS server manager communicatively coupled to the plurality of share entities and configured to manage access of the plurality of share entities to a shared data storage, wherein the NSS server manager is further configured to manage access of the plurality of share entities by configuring at least one of the plurality of NSS client managers to manage access to the shared data storage of an associated one of the respective plurality of share entities, wherein the NSS server manager is communicatively coupled to the plurality of share entities over a mixed in-vehicle network (IVN) including a plurality of different network types.

### CROSS-REFERENCE TO RELATED APPLICATIONS

The present application is a continuation of, and claims priority to, PCT Patent Application Serial No. PCT/US2025/010490, filed on Jan. 6, 2025, published on Jul. 17, 2025, as International Publication No. WO2025/151379, and entitled “SYSTEM, METHOD, AND APPARATUS TO IMPLEMENT A SHARED STORAGE FOR END POINTS ON A VEHICLE” (Attorney Docket No. SONA-0018-WO).

PCT Patent Application Serial No. PCT/US2025/010490 claims the benefit of and priority to U.S. Provisional Patent Application 63/618,612, filed on 8 Jan. 2024, entitled “SYSTEM, METHOD, AND APPARATUS TO IMPLEMENT A SHARED STORAGE FOR END POINTS ON A VEHICLE” (SONA-0018-P01).

Each of the foregoing patent applications is incorporated herein by reference in the entirety for all purposes.

### SUMMARY

Embodiments of the present disclosure provide for a number of improvements over previously known systems having multiple computing devices that communicate over various networks on a vehicle. Example and non-limiting benefits of the present disclosure include providing robust and conveniently configured shared storage operations for controllers of the vehicle, allowing for consolidation of high capability computing power and/or memory storage capability to one, or a few, controllers on the vehicle, reducing component costs for the vehicle and more easily providing capability for expansion and growth of features, algorithms, and other aspects requiring computing resource support. Example benefits include configuring storage utilizing a policy approach, which allows for adjusting storage configurations without requiring a software update to the vehicle, with consequent impact to validation, testing, and/or certification for the vehicle. Example benefits include utilizing scheduled capability such that appropriate devices, flows, applications, or the like on the vehicle can utilize high capability (e.g., fast) memory where it benefits vehicle operations, and allowing other devices, flows, applications, or the like, to utilize lower capability (and cheaper) memory where such memory does not impact operations for those devices. Further, as the needs of devices on the vehicle change over time, the configuration of the shared memory utilization can readily adapt. Example benefits include creating data structures in the shared memory that provide for convenient analysis and troubleshooting, for example structuring the stored memory in data structures that can be indexed, tagged, and/or queried, and allowing for relationships to be evident within the stored data to support various analyses for the vehicle and/or the data. Example benefits include utilizing scheduled trajectories for the stored data, allowing aging data to be preserved to the extent possible, and allowing the system to adapt to changing needs of the vehicle and devices thereon. Further, the configuration for aging data treatment can be readily adjusted over time without requiring software changes in the vehicle. Example benefits allow for flexibility in storage types and/or file storage systems, including allowing for multiple systems on the same vehicle, allowing for greater flexibility in designing and programming computing devices to support applications, flows, and/or features on the vehicle. Any given embodiment may utilize one or more, or all, of the benefits set forth preceding. Additionally, a given embodiment may not utilize the foregoing benefits, but nevertheless may benefit from other aspects of the present disclosure.

In some aspects, the techniques described herein relate to a system for providing shared data storage in a vehicle, including: a plurality of network shared storage (NSS) client managers associated with a respective plurality of share entities in the vehicle; and an NSS server manager communicatively coupled to the plurality of share entities and configured to interpret a shared storage scheme, and to manage access of the plurality of share entities to a shared data storage in response to the shared storage scheme; and wherein the NSS server manager is further configured to manage access of the plurality of share entities by configuring at least one of the plurality of NSS client managers to manage access to the shared data storage of an associated one of the respective plurality of share entities in the vehicle.

In some aspects, the techniques described herein relate to a system for providing shared data storage in a vehicle, including: a plurality of network shared storage (NSS) client managers associated with a respective plurality of share entities in the vehicle; and an NSS server manager communicatively coupled to the plurality of share entities and configured to: receive a shared storage scheme from a system external to the vehicle; and manage access of the plurality of share entities to a shared data storage according to the shared storage scheme by configuring at least one of the plurality of NSS client managers including distributing the shared storage scheme to the at least one of the plurality of NSS client managers.

In some aspects, the techniques described herein relate to a system for providing shared data storage in a vehicle, including: a plurality of network shared storage (NSS) client managers associated with a respective plurality of share entities in the vehicle; and an NSS server manager communicatively coupled to the plurality of share entities and configured to manage access of the plurality of share entities to a shared data storage, wherein the NSS server manager is further configured to manage access of the plurality of share entities to the shared data storage by configuring at least one of the plurality of NSS client managers to implement a storage parameter for an associated one of the plurality of share entities.

In some aspects, the techniques described herein relate to a system for providing shared data storage in a vehicle, including: a plurality of network shared storage (NSS) client managers associated with a respective plurality of share entities in the vehicle; and an NSS server manager communicatively coupled to the plurality of share entities and configured to manage access of the plurality of share entities to a shared data storage, wherein the NSS server manager is further configured to manage access of the plurality of share entities by configuring at least one of the plurality of NSS client managers to manage access to the shared data storage of an associated one of the respective plurality of share entities according to an organizing parameter for at least some data of the shared data storage.

In some aspects, the techniques described herein relate to a method for managing access of a plurality of share entities to a shared data storage in a vehicle, the method including: obtaining an organizing parameter from a shared storage scheme; and configuring, by a network shared storage (NSS) server manager, at least one of a plurality of NSS client managers to manage access to the shared data storage of an associated one of the respective plurality of share entities according to the organizing parameter, wherein the organizing parameter includes tags associated with the at least some data.

In some aspects, the techniques described herein relate to a system for providing shared data storage in a vehicle, including: a plurality of network shared storage (NSS) client managers associated with a respective plurality of share entities in the vehicle; and an NSS server manager operating on a central communication controller and communicatively coupled to the plurality of share entities and configured to manage access of the plurality of share entities to a shared data storage, wherein the NSS server manager is further configured to manage access of the plurality of share entities by configuring at least one of the plurality of NSS client managers to manage access to the shared data storage, and wherein the shared data storage includes at least one shared storage location, and the at least one shared storage location includes a central storage location accessed via the central communication controller.

In some aspects, the techniques described herein relate to a system for providing shared data storage in a vehicle, including: a plurality of network shared storage (NSS) client managers associated with a respective plurality of share entities in the vehicle; and an NSS server manager communicatively coupled to the plurality of share entities and configured to manage access of the plurality of share entities to a shared data storage, wherein the NSS server manager is further configured to manage access of the plurality of share entities by configuring at least one of the plurality of NSS client managers to manage access to the shared data storage of an associated one of the respective plurality of share entities, wherein the NSS server manager is communicatively coupled to the plurality of share entities over a mixed in-vehicle network (IVN) including a plurality of different network types.

In some aspects, the techniques described herein relate to a system for providing shared data storage in a vehicle, including: a plurality of network shared storage (NSS) client managers associated with a respective plurality of share entities in the vehicle; and an NSS server manager communicatively coupled to the plurality of share entities and configured to manage access of the plurality of share entities to a shared data storage, including managing a partitioned file system on the shared data storage, wherein the NSS server manager is further configured to manage access of the plurality of share entities by configuring at least one of the plurality of NSS client managers to manage access to the partitioned file system on the shared data storage by an associated one of the respective plurality of share entities.

In some aspects, the techniques described herein relate to a system for providing shared data storage in a vehicle, including: a plurality of network shared storage (NSS) client managers associated with a respective plurality of share entities in the vehicle; and an NSS server manager communicatively coupled to the plurality of share entities and configured to manage access of the plurality of share entities to a shared data storage, wherein the NSS server manager is further configured to manage access of the plurality of share entities by configuring at least one of the plurality of NSS client managers to manage access to the shared data storage by an associated one of the respective plurality of share entities based on a memory identification provided by the NSS server manager.

In some aspects, the techniques described herein relate to a system for providing shared data storage in a vehicle, including: a plurality of network shared storage (NSS) client managers associated with a respective plurality of share entities in the vehicle; and an NSS server manager communicatively coupled to the plurality of share entities and configured to interpret a shared storage scheme, and to manage access of the plurality of share entities to a shared data storage in response to the shared storage scheme; and wherein the NSS server manager is further configured to manage access of the plurality of share entities by configuring at least one of the plurality of NSS client managers to manage access to the shared data storage of an associated one of the respective plurality of share entities in the vehicle, the NSS server manager further configured to provide an application programming interface (API) for a user application to retrieve and manage data of the shared data storage.

In some aspects, the techniques described herein relate to a system, including: a network shared storage (NSS) server configured to apply a shared storage policy for a vehicle network having a plurality of end points thereon; and a plurality of client servers each configured to selectively provide communications on the vehicle network in response to the shared storage policy, each one of the plurality of client servers associated with at least one end point of the plurality of end points.

In some aspects, the techniques described herein relate to a system, wherein the NSS server is positioned on one of the end points of the plurality of end points.

In some aspects, the techniques described herein relate to a system, further including a shared storage selectively available to each one of the plurality of end points.

In some aspects, the techniques described herein relate to a system, wherein the NSS server is further configured to apply the shared storage policy by performing at least one operation, in response to the shared storage policy, selected from: allowing utilization of a prescribed amount of the shared storage to end points of the plurality of end points; allowing communications to store data associated with an accessing end point; allowing communications to retrieve data associated with an accessing end point; moving data associated with an accessing end point between memory locations within the shared storage; moving data associated with an accessing end point to a cloud storage; moving data associated with an accessing end point to a local storage; configuring a partition and/or a volume of the shared storage; applying a priority value for any one or more of the foregoing, the priority value associated with at least one of: the accessing end point, a flow associated with the accessing end point, an application associated with the accessing end point, or a type value for the data.

In some aspects, the techniques described herein relate to a system, wherein the shared storage is distributed onto more than one of the plurality of end points.

In some aspects, the techniques described herein relate to a system, wherein the shared storage is positioned on a single one of the plurality of end points.

In some aspects, the techniques described herein relate to a system, wherein the NSS server is positioned on the single one of the plurality of end points.

In some aspects, the techniques described herein relate to a system, wherein the NSS server is further configured to interpret the shared storage policy from an external device.

In some aspects, the techniques described herein relate to a system, wherein the NSS server is further configured to interpret the shared storage policy as one of a full policy or a policy update.

### BRIEF DESCRIPTION OF THE DRAWINGS

FIG. 1 depicts an example system for providing shared data storage in a vehicle according to example embodiments.

FIG. 2 depicts an example system for providing shared data storage in a vehicle according to example embodiments.

FIG. 3 depicts an example system for providing shared data storage in a vehicle according to example embodiments.

FIG. 4 depicts an example system for providing shared data storage in a vehicle according to example embodiments.

FIG. 5 depicts an example communication tunnel of a system for providing shared data storage in a vehicle according to example embodiments.

FIGS. 6A-6B depict, as a workflow, an example on vehicle implementations of a policy according to example embodiments.

FIG. 7 depicts, as a workflow, an example policy implementation with an external device operating a digital twin to monitor and confirm policy implementation, according to example embodiments.

FIG. 8 depicts an example implementation for shared storage operations in response to a shutdown event according to example embodiments.

FIGS. 9-10 depict, as a workflow, an example implementation for operations to apply a policy through a shutdown and restart event according to example embodiments.

FIGS. 11-12 depict, as a workflow, an example implementation for operations to begin shared storage operations after a startup of the vehicle according to example embodiments.

FIG. 13 depicts an example implementation of runtime for shared storage operations according to example embodiments.

FIG. 14 depicts an example shared storage scheme of a shared storage system according to example embodiments.

FIG. 15 depicts an example shared data storage of a shared storage system according to example embodiments.

FIG. 16 depicts an example organizing parameter of a shared storage system according to example parameters.

FIG. 17 depicts a display device of a shared storage system according to example embodiments.

FIG. 18 depicts an example shared storage system according to example embodiments.

FIG. 19 depicts share entities of a shared storage system according to example embodiments.

FIG. 20 depicts a method for managing access of a plurality of share entities of a shared storage system according to example embodiments.

### DETAILED DESCRIPTION

Previously known systems for providing vehicle network communications, supporting related data collections, providing automated vehicle responses or actions, and implementing updates to these operations suffer from a number of challenges. Among other challenges, vehicles have a large and increasing number of smart sensors and devices, connected utilizing a number of networks, network configurations, physical locations throughout the vehicle, and related to distinct systems or operations of the vehicle. The environment for these is changing rapidly, largely driven by creating greater capability, automation, and additional features for the vehicle. By contrast, fundamental operations of the vehicle, including for example motive power control, emissions control, or the like, have strong pressure to maintain stability and utilize already certified and reliable components and devices. Accordingly, vehicles have a mix of devices with varying capabilities, and mixed pressure to transition systems to more capable versions and to promote stability and reduce change for many fundamental functions of the vehicle. The general direction is to provide more capable systems, to generate increasing amounts of data, to facilitate an increasing number of higher capability controls, and to host both more numerous and more capable control functions (e.g., with resulting larger and more numerous algorithm instruction sets). Further, vehicle development is challenged by an extremely cost sensitive environment, increasing consequence for data security weaknesses, and increasing attention to data security and data privacy concerns.

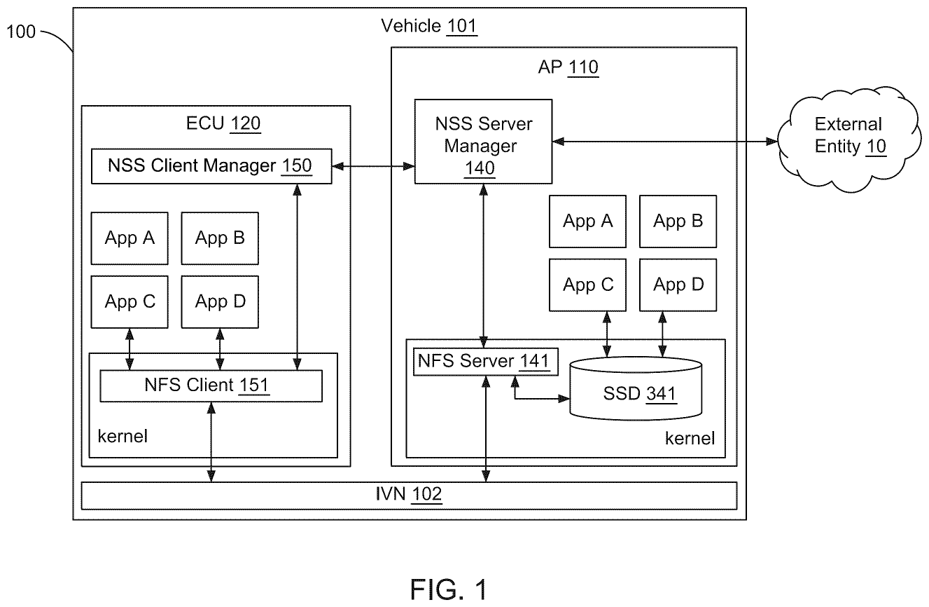

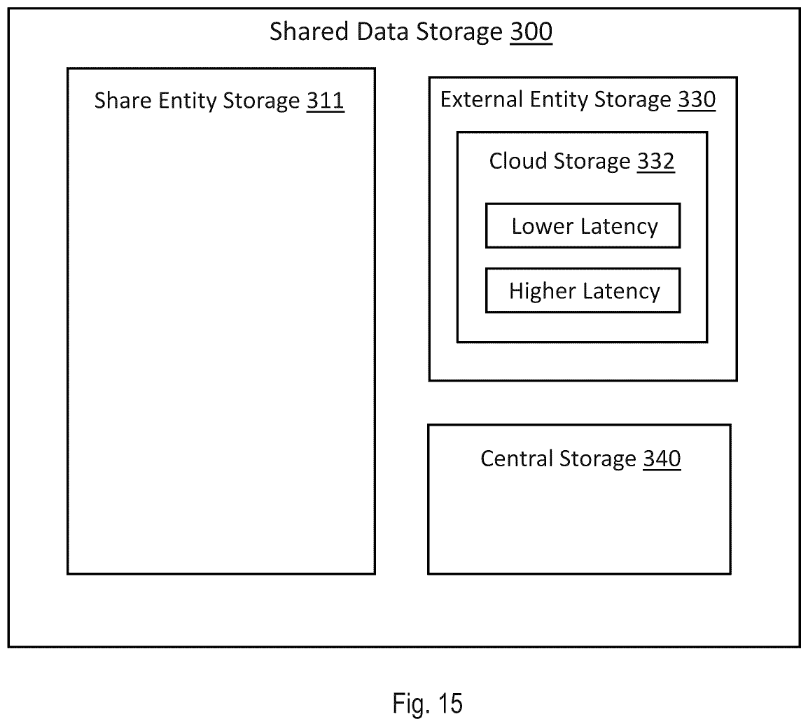

Referencing FIG. 1, an example system 100 for providing shared data storage (which may also be referred to herein as shared network storage) on a vehicle 101 is schematically depicted. The example system 100 provides for shared data storage 300 (to be discussed with reference to FIG. 15), which allows for end points 113 including but not limited to ECUs (electronic control units) distributed around the vehicle 101, some of which may have lower capabilities with regard to memory storage, to perform operations requiring large data storage without requiring that those ECUs have upgraded hardware such as enhanced memory capability. The utilization of a shared data storage 300 as described by reference to example embodiments herein provides a number of additional benefits in the form of technical improvements, such as to data storage of a vehicle. An example technical improvement includes consolidating capability requirements into fewer components, where distributed memory provided at each component would require that numerous ECUs or other end points have individually managed requirements, managing changes for individual components over time, and requiring that locally stored shared data be requested individually from each host of the data, and communication of the data between individual ECUs each time the data is requested. Another example technical improvement includes providing for consistent security and data management, with the system 100 providing for consistent authentication, encryption, sharing, and editing control for data stored therein. Another example benefit includes significant cost reduction, not only financially but in energy and footprint as well, as individual components can be maintained as lower capability components configured to meet the operational requirements for the individual component, but not requiring extensive storage capability and management of that capability over time and over various vehicle models.

With reference to FIG. 1, an example system 100 according to example embodiments may include at least one network shared storage (NSS) server manager 140 (which may also be referred to herein as an NSS manager 140). In an example, the NSS server manager 140 may execute on one or more processors from computer-readable instructions stored in one or more non-transitory computer readable storage mediums. In some embodiments, as an example, an Application Processor (AP) 110 may host the NSS server manager 140 for the vehicle 101, although embodiments are not limited thereto. The example system 100 may further include a plurality of ECUs 120, each performing certain functions for the vehicle 101 (e.g., operating a sensor, actuator, or a group of these, performing certain operations to support an application or flow of the vehicle, such as an ECU 120 that operates an engine, powertrain system, braking system, HVAC system, etc.). In certain embodiments, an ECU 120 may be an end point on a network of the vehicle, but end points are not limited thereto. An end point may be of any type (e.g., an ECU, a smart sensor, etc.). Additionally, the network (which may be discussed herein with reference to in-vehicle network (IVN) 102) may be of any type (e.g., an ethernet, CAN, LIN, etc.). The AP 110, on which the NSS server manager 140 may be hosted, may be positioned on one of the ECUs 120, on any end point, and/or may be embodied as one of the ECUs 120 and/or an end point. In an example, the AP 110 may be included in a central communication (CCU) controller.

In example embodiments, the example system 100 may include a plurality of network shared storage (NSS) client managers 150 associated with a respective plurality of share entities 111 in the vehicle 101. For example, as illustrated in FIGS. 1 and F, each share entity 111 (e.g., such as the ECU 120 of FIG. 1) may include or otherwise be associated with an NSS client manager 150 that manages operations for the ECU 120 to participate in the shared data storage 300, including for example providing requested data (e.g., data from the given ECU to another ECU, and/or to be stored in the shared data storage 300), accessing requested data, retrieving shared data, editing shared data, and/or implemented updated procedures for shared storage operations. In some examples, an NSS client manager 150 may be executed on the share entity 111 with which it is associated, such as on one or more processors or other circuitry of the share entity, from instructions stored in one or more non-transitory computer-readable storage mediums. For example, as illustrated in FIG. 1, an NSS client manager 150 may be executed on an ECU 120.

In example embodiments, with reference to Figs. F and G, the NSS server manager 140 may be communicatively coupled to a plurality of share entities 111. These share entities 111 may include a plurality of end points 113 of the vehicle, such as ECUs (e.g., the ECU 120 of the example embodiment in FIG. 1), applications, flows, a smart sensor, a smart actuator, etc. In an example, the plurality of end points 113 may include at least one of an ECU or a smart sensor. In another example, the plurality of end points 113 may include at least one of an application or a flow distributed across multiple ones of the plurality of end points 113 and managed by a NSS client manager 150 associated with the at least one of the application or the flow. For example, the application or flow may be executed across the multiple ones of the end points 113.

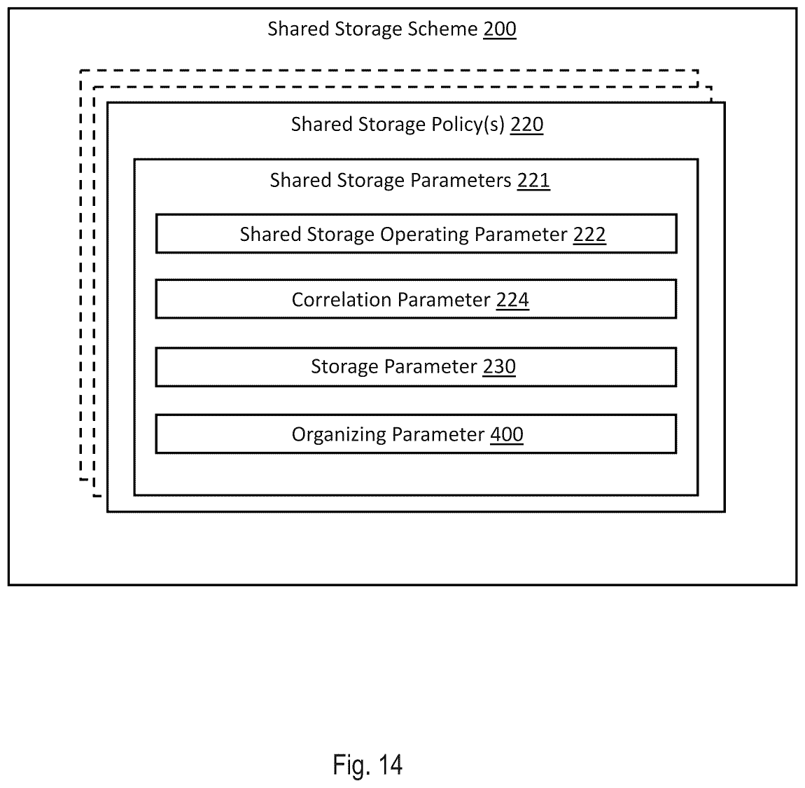

In example embodiments, as illustrated by example in FIG. 1, the NSS server manager 140 may be configured to interpret a shared storage scheme 200 (see FIG. 14), and to manage access of the plurality of share entities to a shared data storage 300 (see FIG. 15), which may be in response to the shared storage scheme 200. In the example of FIG. 1, the NSS server manager 140 may receive and/or interpret the shared storage scheme 200 from an external entity 10, which may be an external device or other system external to the vehicle, such as a cloud/cloud system, in accordance with a shared storage policy 220 (e.g., an updated policy, a new policy, etc.). Indeed, the shared storage scheme 200 including the shared storage policy 220 may be provided to the NSS server manager 140 from the external entity 10. In some examples, with reference to FIG. 14, the shared storage policy 220 may be included in or otherwise integrated into the shared storage scheme 200. In certain embodiments, the shared storage policy 220 and the shared storage scheme 200 may encompass the same aspects. However, a shared storage policy 200 may be more limited, for example where a shared storage policy 220 is utilized to update a portion of the shared storage scheme 200.

Thus, the NSS server manager 140 may manage access of the plurality of share entities 111 to the shared data storage 300 according to the shared storage policy 220 provided by the shared storage scheme 200. In some embodiments, the NSS server manager 140 may manage access of the plurality of share entities to the shared data storage 300 according to the shared storage scheme 200 by configuring at least one of the plurality of NSS client managers 150, including distributing the shared storage scheme 200 to the at least one of the plurality of NSS client managers 150.

With reference to FIG. 14, in some embodiments, the shared storage scheme 200 may include a shared storage policy 220 that prescribes a shared storage operating parameter 222 including at least one of: an amount of storage space of the shared data storage 300 allocated to one or more of the plurality of share entities 111; which of the plurality of share entities 111 are allocated with storage space on the shared data storage 300; a data retention plan for one or more partitions or types of data on the shared data storage 300; a data storage priority between different ones of the plurality of share entities 111 for the shared data storage 300; and/or an access permission for the shared data storage 300.

In some embodiments, the NSS server manager 140 may be further configured to receive a second shared storage scheme, where the second shared storage scheme includes a second shared storage policy that is subject to confines of the shared storage operating parameter 222 of the shared storage policy 220. For example, the second shared storage scheme may not allocate storage space to share entities 111 in a manner that is contrary to the shared storage policy 220. For example, if a certain share entity 111 is allocated only a certain amount of storage space of the shared data storage 300, the second shared storage scheme may not prescribe a greater amount. In certain embodiments, switching between shared storage schemes may support alternate operating states or conditions of the vehicle, for example utilizing a first shared storage scheme in a first operating condition, and a second shared storage scheme in a second operating condition. In certain embodiments, different shared storage schemes may be utilized in different locations (e.g., to adjust for privacy regulations and/or data control regulations in a location), based on performance requirements for the vehicle (e.g., changing the storage priorities for different end points, applications, or flows of the vehicle based on changes in the duty cycle for the vehicle over time), based on total memory availability of the vehicle, or the like. In certain embodiments, the system may have more than two storage schemes available.

In some embodiments, the shared storage operating parameter 222 may indicate that the shared data storage 300 includes data storage provided by the external entity 10—e.g., the system external to the vehicle 101—where the system external to the vehicle may be a cloud system.

In some embodiments, as described by example herein, the shared storage scheme 200 may include a shared storage policy 220 that prescribes a shared storage operating parameter 222, where the shared storage policy 220 may be at least one of a factory policy, an original equipment manufacturer (OEM) policy, or an end use policy. Any type of policy and/or organizing logic for policies are contemplated herein, for example policies may be temporary (e.g., a policy utilized for a rental vehicle), changed when ownership of the vehicle is transferred, adjusted for specific vehicle types such as first responders, commercial vehicles, load hauling vehicles, or the like, where the goals of the shared storage system may change over time and/or as the ownership, mission, and/or required performance for the vehicle changes. For example, the shared storage policy 220 may be a factory policy provided at the time of manufacturing the vehicle 101, and may impose broad shared storage operating parameters 222 within which other shared storage schemes, such as a second shared storage scheme, may operate. For example, the shared storage policy 220 as a factory policy may prescribe certain vehicle-critical communications as high priority, and/or certain vehicle-critical operations requiring memory to have priority access to any allocated shared storage. In an example, a shared storage policy 220 that is a factory policy may be installed on the vehicle at the factory and never change. Beyond that, a second shared storage policy, such that of an OEM policy or an end use policy, may be free to set the priority of other data and/or communications. It should be noted that a factory policy, an OEM policy, and an end use policy are or may be different types of policies, and each may exist simultaneously as part of the same shared storage scheme 200 for the system 100 in addition to a base policy.

In some embodiments, multiple versions of a shared storage policy 220 may exist in, e.g., the external entity 10, which may apply different versions of the shared storage policy 220 to different vehicles based on, e.g., differences in the vehicles. These differences may be automatically adjusted in the shared storage policy 220 by either the external entity 10 and/or the NSS server manager 140 of the respective vehicle 101, such as in view of a base policy of that vehicle. For example, the shared storage policy 220 may be adjusted for a particular vehicle 101 based on the technical features of that vehicle. As one example, for a vehicle 101 that does not include a particular temperature sensor, which would be included as a share entity 111 in versions of the shared storage policy 220 for other vehicles, the version of the shared storage policy 220 to be received by the vehicle is adjusted so as to account for a lack of that particular share entity 111. As another example, a version of the shared storage policy 220 for a particular vehicle 101 may be tailored to the storage available at specific end points 113 of that vehicle, which may differ depending on model, trim level, other installed capabilities, etc.

In some embodiments, the shared storage scheme 200 may include a shared storage policy 220 that prescribes a shared storage operating parameter 222 based on the vehicle 101. For example, in an example including the system external to the vehicle 101, the shared storage policy 220 may include a base policy that is adjusted by the system external to the vehicle 101 based on an aspect of the vehicle 101. That aspect, for example, may be at least one technical capability of the vehicle 101, and may be known by the system external to the vehicle 101. For example, such a system may be operated by the manufacturer and/or other technical persons with knowledge of the technical capabilities of the vehicle 101, either as manufactured or as otherwise installed therein, and the base policy may be adjusted based on knowledge of such technical capabilities. For example, the vehicle 101 may include certain sensors or other features, and if so, the base policy may be adjusted to include a shared storage policy for such features. Or, for example, the base policy may use such features to dictate the shared storage policy. As a specific example, the at least one technical capability may include an ambient temperature sensor of the vehicle 101, and the system external to the vehicle may adjust a shared storage operating parameter 222 of the base policy to be based, at least in part, on a sensed temperature from the ambient temperature sensor. For example, the shared storage operating parameter 222 may be adjusted to prefer set a higher priority for data relating to temperature sensing when the ambient temperature sensor indicates that an ambient temperature is above a threshold amount.

In some examples where the NSS server manager 140 receives the shared storage scheme 200 from an external entity 10 such as a cloud system, such a cloud system may include an external cloud device. Such an external cloud device may be configured to be local to the vehicle 101 and interface with the NSS server manager 140 over a network (e.g., Ethernet, Wifi, Bluetooth, etc.). In that sense, while the cloud system is external to the vehicle 101 insofar as it is not a part of the vehicle 101, it may be inside of or otherwise proximate to the vehicle 101 and may, for example, refer to and/or include components of a “mini-cloud” device. While in some embodiments, the mini-cloud device may be provided to the system 100 in situations where the vehicle 101 and/or device may not have access to the Internet, it may appear to the system 100 (e.g. to the NSS server manager 140) as a typical cloud server with typical cloud functionality. Thus, the external cloud device may be further configured to interface with the NSS server manager 140 as a remote cloud server—for example, by physically connecting to the IVN 102 of the vehicle and/or using Wifi or other wireless interface. In some examples, as discussed by example herein, the external entity 10 such as the external cloud device may provide some or all of the shared data storage 300. In examples, the external cloud device may be embodied in a personal electronic device such as a smartphone or a laptop, and/or may be provided in specialized electronics that are transportable or fixed to the vehicle 101.

In some examples, the external cloud device may include at least one of a service tool, a manufacturer tool, a dealer tool, and/or a cloud based tool. The service tool may be used, for example, by an auto repair shop to retrieve or otherwise manage data stored by the shared data storage 300 for diagnostics and repair. The manufacturer tool may be used, for example, to include a base policy in the shared storage scheme 200 at the time of manufacture, such as setting basic data priorities related to critical vehicle operations. The dealer tool may be used by a dealer to include any additional shared data policies for technical features that were not present at the time of manufacturer. Other cloud-based tools may be used by a variety of entities to access and program the shared storage scheme 200 in accordance with their access, which may be controlled by a pre-existing shared storage scheme 200 existing in the system 100. Indeed, as discussed by example herein, the shared storage scheme 200 may be updated, and the examples provided above may be with regard to an original shared storage scheme 200 or an update to the shared storage scheme 200.

As discussed, in some examples, it may be possible to update the shared storage scheme 200. For example, the NSS server manager 140 may be configured to receive an update to the shared storage scheme 200 from the external entity 10 (e.g., the system external to the vehicle 101) and distribute the update to the shared storage scheme 200 to the plurality of NSS client managers 150.

In some examples, the NSS server manager 140 may be configured to parse the shared storage scheme 200 into relevant portions for two or more of the plurality of NSS client managers 150 (or, e.g., all of the plurality of NSS client managers 150) and configure the two or more of the plurality of NSS client managers 150 based on the relevant portions. And/or, for example, the NSS server manager 140 may distributes appropriate portions of the shared storage scheme 200 (including, for example, portions of the shared storage policy 220) to each NSS client manager 150. In certain embodiments, the NSS server manager 140 may interpret the policy 220 and determine appropriate instructions for each NSS client manager 150—for example, where the NSS client manager 150 instructions are not a portion of the policy 220, but rather, are determined based on the policy 220 (e.g., where the policy sets forth the requirements for shared storage operations, and the NSS server manager 140 determines the consequent instructions for the NSS client manager 150 to achieve the requirements).

Thus, in some examples, the NSS server manager 140 may be configured to distribute the shared storage scheme 200 to multiple ones of the plurality of share entities 111, which may include parsing the shared storage scheme 200 into parsed portions (e.g., appropriate portions) of the shared storage scheme 200 (which may, for example, include portions of the shared storage policy 220) and distributing these parsed portions of the shared storage scheme 200 to respective ones of the multiple ones of the plurality of NSS client managers 150.

The system 100 of example embodiments may include all or some of the shared data storage 300. For example, with reference to the example system 100 of FIG. 1 includes a shared data storage 300 including a solid state drive (SSD) 341, which may be associated with the AP 110, and which may be administered by (and, in some examples, at least conceptually comprised by) an network file system (NFS) server 141, which includes storage utilized to support the shared data storage 300 operations. The solid state drive 341 is provided merely as an example of shared data storage, and as illustrated in FIG. 15, in example embodiments, the shared data storage 300 may include share entity storage 311 associated with one or more of the plurality of share entities and/or external entity storage 330 associated with an external device, such as cloud storage 332. In an example, the solid state drive 341 associated with the AP 110 may provide all or part of the central storage 340. In some examples, the share entity storage 311 associated with one or more of the plurality of share entities 111 may be administered by (and, in some examples, at least functionally comprised by) an NFS client server 151, which may include and/or interface with a local storage device 351, and which may include a core operating system component such as a kernel (e.g., a Linux kernel). And in some examples, the central storage 300 may be administered by (and, in some examples, at least functionally comprised by) an NFS server 141, which may include and/or interface with a local storage device such as the solid state drive 341, and which may include a core operating system component such as a kernel (e.g., a Linux kernel).

In example embodiments, each, any, or all of the shared data storage 300 examples described herein, including but not limited to the share entity storage 311 (e.g., local storage devices 351), external entity storage 330 (e.g., in a cloud server), central storage 340, and others, may include, as the physical storage, at least one of a CD-ROM, DVD, memory, hard disk, flash drive, RAM, ROM, cache, or the like.

In example embodiments, the NSS server manager 140 may manage access of the plurality of share entities 111 to the shared data storage 300 in response to the shared storage scheme 200. For example, the NSS server manager 140 may be configured to manage access of the plurality of share entities by configuring at least one of the plurality of NSS client managers 150 to manage access to the shared data storage 300 of an associated one of the respective plurality of share entities in the vehicle 101.

For example, the NSS server manager 140 may be configured to configure the at least one of the plurality of NSS client managers 150 to at least one of: control utilization (e.g., data utilization) of the associated one of the respective plurality of share entities 111; notify the NSS server manager 140 of at least one of the utilization or a remaining space in the associated one of the respective plurality of share entities 111 (e.g., in the share entity storage 311 of the share entity 111); instruct the associated one of the respective plurality of share entities 111 to directly communicate with the NSS server manager 140 according to a shared storage interaction profile (e.g., to change whether the share entity 111 communicates through another entity and/or directly to the NSS server manager 140, for example during a response to off-nominal conditions or a failure, due to changes in one or more of the share entities for available local storage and/or storage requirements, and/or due to a change in hardware and/or configuration of one or more of the share entities 111); perform a processing operation to or from the associated one of the respective plurality of share entities 111; pre-retrieve at least some of the data stored on the associated one of the respective plurality of share entities 111 (e.g., on the share entity storage 311 of the share entity 111); or set a communication address for the at least some of the data stored on the associated one of the respective plurality of share entities 111 (e.g., of the data stored in the share entity storage 311 of the share entity 111).

With reference to FIG. 14, in some embodiments, according to the shared storage policy 220, the NSS server manager 140 may allocate a specified amount of storage in the shared data storage 300 to some (or all) of the plurality of share entities 111. For example, the NSS server manager 140 may allocate the specified amount of storage based on a correlation parameter 224 of the some of the plurality of share entities 111. In an example, the correlation parameter 224 may be part of the shared storage policy 220 and/or the shared storage scheme 200.

In some examples, the correlation parameter 224 may include a reduced variability in a storage tendency between the some of the plurality of share entities 111. For example, some (e.g., two or more) of the share entities 111 may have a shared tendency (e.g., a reduced variability compared to what is typical of share entities 111) in their storage spare utilization. For example, some of the share entities 111 may have a shared tendency to at least one of: read or write data at a same time, read or write data during a same operating condition, require a same type of processing support for storage of data, require a same type of storage support for storage of data, or require a same permission or priority to access data. Thus, there may be efficiencies in allocating the specified amount of storage for such share entities based on this correlation parameter 224, which may incorporate their shared tendency for storage space utilization, so that adequate storage space utilization may be provided to each of the share entities 111 in view of their shared and/or simultaneous needs.

As another example, the correlation parameter 224 may, for example, include a reverse synergy in the storage tendency between the some of the plurality of shared entities 111. For example, there may be a reverse synergy in a tendency for storage space utilization between some of the plurality of share entities 111. This reverse synergy may include at least one of: an inverse tendency to read or write data at a same time, an inverse tendency to read or write data during a same operating condition, an inverse tendency for a same type of processing support for storage of data, an inverse tendency for a same type of storage support for storage of data, or an inverse tendency for a same permission or priority to access data. Thus, there may be efficiencies in allocating the specified amount of storage with knowledge (as incorporated into the correlation parameter 224) that demand for storage space utilization between some of the share entities 111 has a reverse synergy, such that the allocation of storage space to these share entities 111 may be less than would be typically expected for such storage entities 111 without knowledge of the reverse synergy.

In some embodiments, the correlation parameter may include a simplified storage allocation between the some of the plurality of shared entities. For example, the simplified storage allocation may include a simplified allocation of storage space between the some of the plurality of share entities. Or, for example, the simplified storage allocation may include a simplification of permissions or priority operations between the some of the plurality of share entities. Or, for example, the simplified storage allocation may include a simplification of network communication management between the some of the plurality of share entities.

In some embodiments, the system 100 may include the shared data storage 300 and the plurality of share entities, and the shared data storage 300 may include a plurality of solid state drives distributed in at least some of the plurality of share entities.

In some embodiments, the NSS server manager 140 may be configured to change the shared storage scheme 200 from a first scheme to a second scheme at a predetermined condition. For example, the predetermined condition may include at least one of a shutdown operation, a restart operation, a load condition, a vehicle speed condition, or acknowledgement by an operator of the vehicle, and/or other current operating conditions of the vehicle 101 and/or system 100 (e.g., current power throughput, operating mode such as running, cruising, start-up, shutdown, high altitude operation, etc.).

In some examples, the change to the second scheme may not alter any core vehicle 101 control data stored in any of the plurality of share entities 111 (e.g., in share entity storage 311) in the vehicle 101. For example, at detection of a predetermined condition including a shutdown operation, the core vehicle 101 control data may be stored in the shared data storage according to the second scheme just like it is stored according to the first scheme. However, the same with under both the second scheme and the first scheme. However, embodiments are not limited thereto, and in some examples, the change to the second scheme may cause at least one of the NSS server manager 140 or the at least one of the plurality of NSS client managers 150 to perform a reduction operation on at least some core vehicle control data, the reduction operation including at least one of compression, summarizing, or downsampling. For example, the reduction operation may be performed in order to adequately preserve the core vehicle control data before power is lost during, e.g., an emergency shutdown event where the vehicle 101 will be able to provide power to the shared data storage 300 for less than the typical duration of time at a shutdown event.

In example embodiments, the NSS server manager 140 may be configured to manage access of the plurality of share entities 111 to the shared data storage 300 by configuring at least one of the plurality of NSS client managers 150 to implement a storage parameter 230 for an associated one of the plurality of share entities 111. In some embodiments, the storage parameter 230 may be a part of a shared storage policy 220 and/or the shared storage scheme 200. And, for example, the NSS server manager 140 may be configured to obtain the storage parameter 230 from the shared storage scheme 200.

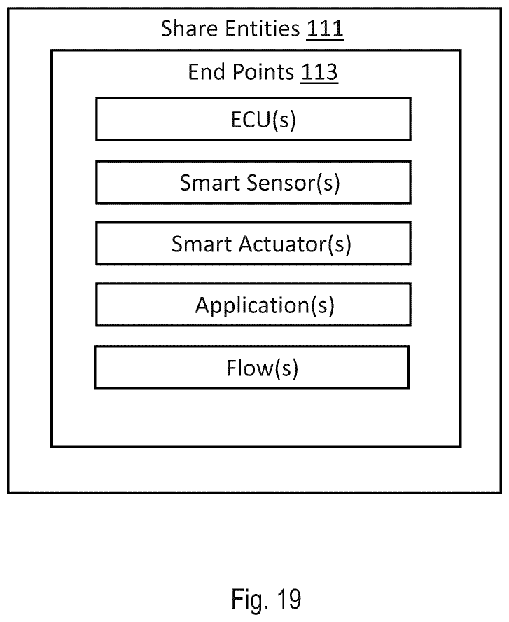

As described by example herein, the plurality of share entities 111 may include at least one of an application or a flow (see FIG. 19) distributed across multiple end points 113 of a network (e.g., IVN 102) of the vehicle 101, and the at least one of the plurality of NSS client managers 150 may be configured to implement the storage parameter 230 for the at least one of the application or the flow. The multiple end points 113 on which the application or flow is distributed may include at least one of a controller, an electronic control unit (ECU), a smart sensor, a smart actuator, a sensor, or an actuator. However, embodiments are not limited thereto, and in examples, the multiple end points 113 may include any end point as described by example herein and/or as may be understood to be included by one of ordinary skill in the art.

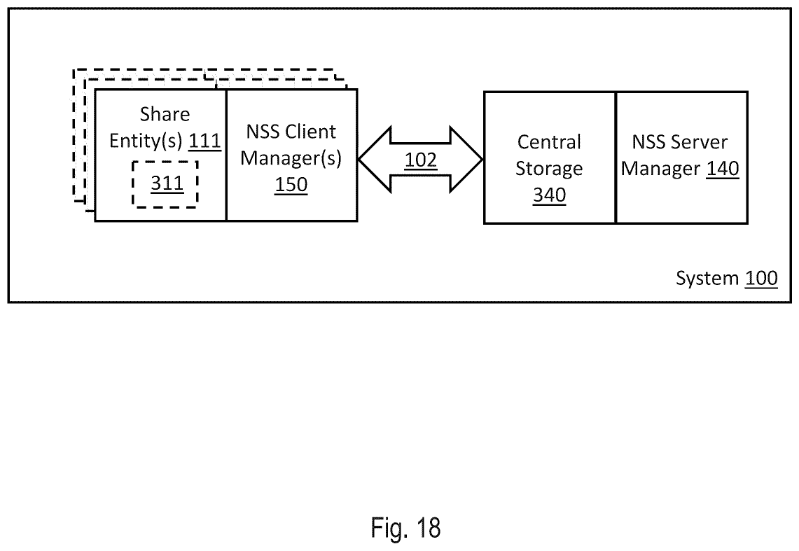

Meanwhile, as described herein and with reference to FIG. 18, the NSS client managers 150 may be associated with a respective plurality of share entities 111 in the vehicle 101, and the NSS server manager 140 may configure at least one of the plurality of NSS client managers 150 to implement the storage parameter 230 for an associated one of the plurality of share entities 111. This associated one of the plurality of share entities 111 may include at least one of a controller, an electronic control unit (ECU), a smart actuator, or a smart sensor, and the at least one of the plurality of NSS client managers 150 may be configured to implement the storage parameter 230 for the at least one of the controller, the ECU, the smart actuator, or the smart sensor.

In some embodiments, the at least one of the plurality of NSS client managers 150 may be configured by the NSS server manager 140 to implement the storage parameter 230, where the storage parameter 230 may include at least one of: an access permission of the at least one of the plurality of share entities 111 to the shared data storage 300; an allocation of a portion of the shared data storage 300 to the at least one of the plurality of share entities 111; a location of the portion of the shared data storage 300 (e.g., with reference to FIG. 15 as an example, whether the allocated portion is in share entity storage 311 (and if so, which share entity), external entity storage 330, and/or central storage 340); a priority of the at least one of the plurality of share entities 111 to the portion of the shared data storage 300; a data retention policy of data stored by the at least one of the plurality of share entities 111 on the shared data storage 300; or a dynamic modification policy of data stored by the at least one of the plurality of share entities 111 on the shared data storage 300.

In some examples, the storage parameter 230 may include the access permission, and the at least one of the plurality of NSS client managers 150 may be configured to control, based on the access permission, when the at least one of the plurality of share entities 111 can read or write data on the shared data storage 300.

In some examples, the storage parameter 230 may include the allocation of the portion of the shared data storage 300, and the portion may include a partition of the shared data storage 300.

In some examples, the storage parameter 230 may include the location of the portion, and the at least one of the plurality of NSS client managers 150 may be configured to select the location of the portion based on an access speed of storage at the location of the portion.

In some examples, the storage parameter 230 may include the priority of the at least one of the plurality of share entities 111 to the portion, and the at least one of the plurality of NSS client managers 150 may be configured to determine, based on the priority, a priority of access of the at least one of the plurality of share entities 111 relative to other ones of the plurality of share entities 111 to the portion. For example, the at least one of the plurality of share entities 111 may have a higher priority to the portion compared to some of the other ones of the plurality of share entities 111 while having a lower priority to the portion compared to others of the other ones.

In some examples, the storage parameter 230 may include the data retention policy, and the at least one of the plurality of NSS client managers 150 may be configured to determine, based on the data retention policy, a length of time data stored by the at least one of the plurality of share entities in the portion of the shared data storage 300 is kept and an action taken after the length of time. In some examples, this action may include at least one of moving the data, compressing the data, summarizing the data, notifying the at least one of the plurality of share entities of a data limit, or deleting at least some of the data.

In some examples, the storage parameter 230 may include the dynamic modification policy, and the at least one of the plurality of NSS client managers 150 may be configured to determine, based on the dynamic modification policy, when the associated one of the plurality of share entities 111 is allowed to write data to the portion of the shared data storage 300.

In some examples, the storage parameter 230 may be based on a type of the at least one of the plurality of share entities. And in some examples, the storage parameter 230 may be based on a criticality of the at least one of the plurality of share entities to a safe operation of the vehicle 101.

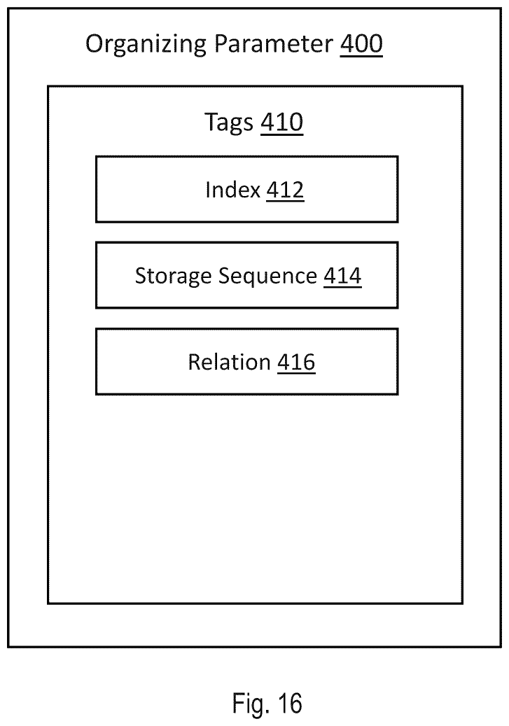

In example embodiments, with reference to FIG. 16, the NSS server manager 140 may be configured to manage access of the plurality of share entities by configuring at least one of the plurality of NSS client managers 150 to manage access to the shared data storage 300 of an associated one of the respective plurality of share entities 111 according to an organizing parameter 400 for at least some data of the shared data storage 300. In some embodiments, the organizing parameter 400 may be a part of a shared storage policy 220 and/or shared storage scheme 200, although embodiments are not limited thereto.

In some embodiments, the organizing parameter 400 may include tags 410 associated with the at least some data. These tags 410 may be queryable by an external entity 10, such as an external device (e.g., cloud) 10 via the NSS server manager 140. In an example, the at least one of the plurality of NSS client managers 150 that is configured by the NSS server manager 140 as described above may be configured to store the tags 410 as metadata for the at least some data.

In some embodiments, the tags 410 may include at least one of an index 412 of the at least some data, a storage sequence 414 of the at least some data, or a relation 416 between at least a portion of data of the at least some data.

For example, the tags 410 may include the storage sequence 414 of the at least some data, and this storage sequence 414 may indicate how the at least some data is stored in the shared data storage 300 to thereby be used as retrieval information by a querying entity. For example, data may be collected for a specific purpose, such as responsive to a diagnostic operation, analysis of a fleet for performance improvements, and/or to monitor a change in an application or flow of the vehicle, where the tags assist in rapidly finding the relevant data, as well as confirming that the data was collected properly under the conditions for the test.

In some embodiments, the tags may include the relation 416 between the at least the portion of the data of the at least some data to provide data that is selectable according the relation by an external entity 10.

In some embodiments, the organizing parameter 400 may include or otherwise involve SQL data.

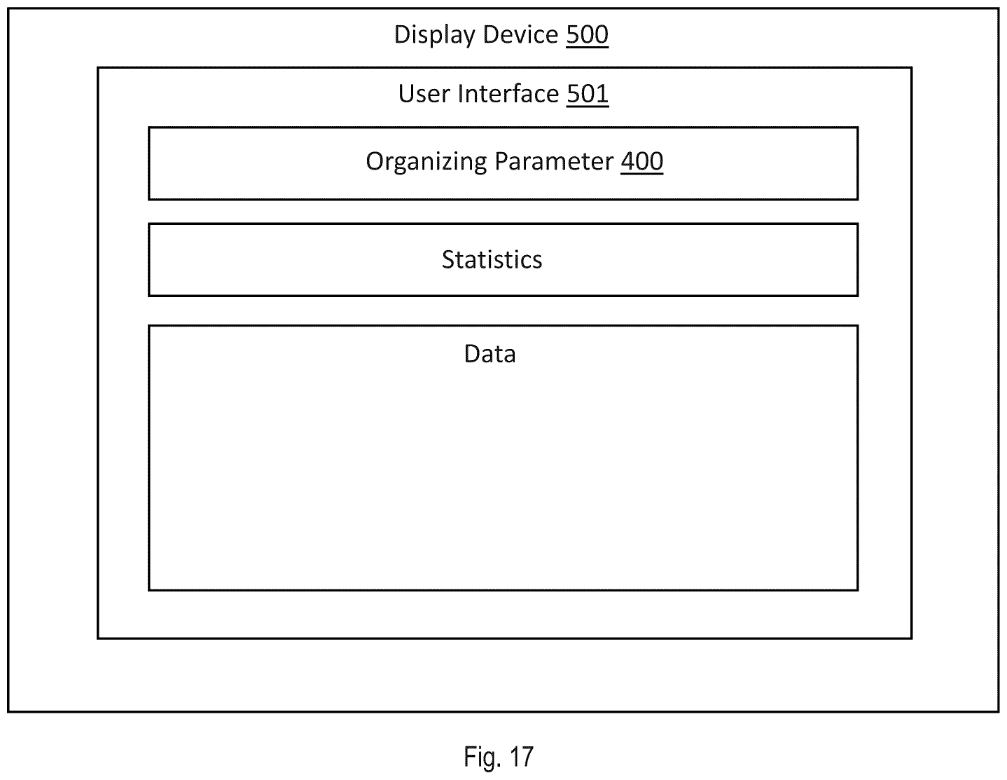

In some embodiments, with reference to FIG. 17, the NSS server manager 140 may be further configured to provide a user interface 501 on a display (e.g., display device) 500 to display, among other things, the organizing parameter 400 for the at least some data and allow a user to select retrieval of the at least some data according to the organizing parameter 400.

In some embodiments, the NSS server manager 140 may include the organizing parameter 400 for the at least some data at a data event. This data event may, for example, be at least one of an upload of the at least some data to a cloud server, a predetermined time period, or a detected event that indicates an importance of the at least some data.

In some embodiments, the NSS server manager 140 may be further configured to obtain the organizing parameter 400 from a shared storage scheme 200, such as a shared storage policy 220.

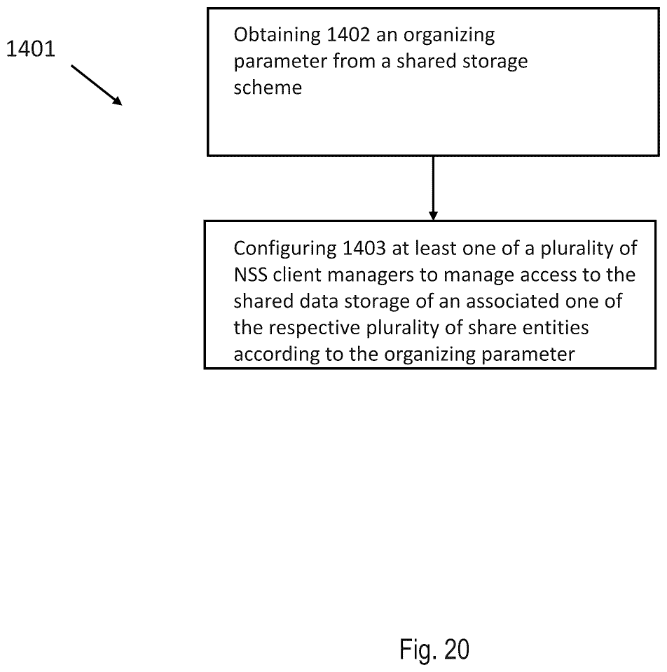

In example embodiments, with reference to FIG. 20, a method 1401 for managing access of a plurality of share entities 111 to a shared data storage 300 in a vehicle 101 may include obtaining 1402 an organizing parameter 400 from a shared storage scheme 200. The method may further include configuring 1403, by a network shared storage (NSS) server manager 140, at least one of a plurality of NSS client managers 150 to manage access to the shared data storage 300 of an associated one of the respective plurality of share entities 111 according to the organizing parameter 400. The organizing parameter 400 may include tags 410 associated with the at least some data. In some embodiments, the method 1401 may include storing the tags 410 as metadata for the least some data.

In some embodiments, the method 1401 may further include querying, by an external entity 10 such as an external device, the tags 410 via the NSS server manager 140. Furthermore, the tags 410 may include at least one of an index 412 of the at least some data, a storage sequence 414 of the at least some data, or a relation 416 between at least a portion of data of the at least some data.

In an example embodiment where the tags 410 include the storage sequence 414 of the at least some data, the storage sequence 414 may indicate how the at least some data is stored in the shared data storage 300 to thereby be used as retrieval information by a querying entity. Furthermore, the method 1401 may include using, by a querying entity, the storage sequence 414 to retrieve the at least some data from the shared data storage 300. The querying entity may be an offline user, for example a manufacturer, engineering personnel, service personnel, or the like, where the data may be collected for a test, diagnostic, troubleshooting, and/or as a part of an iterative improvement operation.

In some embodiments, the method 1401 may further include the NSS server manager 140 including the organizing parameter 400 for the at least some data at a data event. The data event may be at least one of an upload of the at least some data to an external entity 10 such as a cloud server, a predetermined time period, or a detected event that indicates an importance of the at least some data.

In some embodiments, the method 1401 may further include causing to be displayed, on a display device 500, the organizing parameter 400 for the at least some data. For example, the display device 500 may be associated with an external entity, and may be operated by a user, and the NSS server manager 140 may provide the organizing parameter 400 to the external entity 10 for display. The method 1401 may further include receiving a selection from the user to retrieve the at least some data according to the organizing parameter 400, and the at least some data may be accordingly retrieved (e.g., by the NSS server manager 140) and be caused to be displayed on the display device 500.

In example embodiments, an NSS server manager 140 may be configured to manage access of a plurality of share entities 111 by configuring at least one of a plurality of NSS client managers 150 (which, as described by example herein, may be associated with a respective plurality of the share entities 111 in the vehicle 101) to manage access to the shared data storage 300 of an associated one of the respective plurality of share entities 111 in the vehicle 101. The NSS server manager 140 may be further configured to provide an application programming interface (API) or other ability for a user application (e.g., of an external entity 10) to retrieve and manage data of the shared data storage 300.

Further, in some embodiments, the API may permit the user application to manage a buffering parameter of write operations for the data of the shared data storage 300. For example, the buffering parameter may set a time duration of data to be prefetched, and/or a size of a chunk of data to be prefetched, where such data to be written to the shared data storage 300, e.g., from the external entity 10 and/or a share entity 111 within the vehicle. This buffering parameter may take into account electromagnetic (EMI) noise on the IVN 102 and noise at transitions (e.g., between the external entity 10 to the system 100 and/or NSS server manager 140, between the NSS server manager and the location of the shared data storage 300, etc.). Such noise may cause dropouts and other communication failures along the communication path between data source and shared data storage 300, as may communication congestion. Thus, the noise and/or other factors along the communication path may be analyzed and a typical dropout period ascertained. The buffering parameter may be based on exceeding this typical dropout period.

Thus, in an example, the buffering parameter includes at least one of an amount of pre-fetching of data to be written to account for electromagnetic noise (e.g., as indicated by a time duration), or a size of chunks of the data to be written. Or, for example, how fast ad/or how often data should be written. And, in an example, the buffering parameter may include a plurality of buffering parameters corresponding to respective transitions in the system 100. These transitions may include at least one of a transition between the NSS server manager 140 and at least one of the plurality of NSS client managers 150, or a transition between the at least one of the plurality of NSS client managers 150 and a respective one of the plurality of share entities 111.

In an example embodiment, each share entity 111 (e.g., end points, applications, flows, etc.) authorized to utilize the shared data storage 300 (e.g., in accordance with the shared storage scheme 200) may access the shared data storage 300, which may include storing data, reading data, and/or editing stored data, as may be described in more detail herein. The authorizations for each entity 111 (e.g., as set forth in the shared storage scheme 200) may vary according to the data source (e.g., the entity providing the data, and/or the entity having ownership or control of the data), data type (e.g., controls data, A/V data, sensor data, performance data, etc.), and/or the current operating conditions (e.g., authorization may be varied according to: current power throughput; vehicle speed; operating mode such as running, cruising, start-up, shutdown, high altitude operation, etc.). For example, the utilization of the shared data storage 300 and/or authorization of entities 111 to utilize and/or access data in the shared data storage 300 may be varied according to the operating condition, for example to reserve storage before major operation, reduce network throughput (e.g., network communications utilized to store and/or access the shared storage data), and/or during sensitive operating conditions (e.g., high utilization, busy conditions where control communications throughput is high, during start-up operations to ensure successful sequencing, and/or during shutdown operations to ensure that shutdown operations can be completed and no memory is corrupted).

In certain embodiments, priority for access to the shared data storage 300 may be provided between various entities 111 interacting with the shared data storage 300, for example according to a priority of related end points, ECUs, applications, a type of data being stored or communicated, or the like. The utilization of priority operations may relate to network communications, shared storage utilization (including direct utilization of the storage, and/or communication resources to read, write, or edit the shared storage data), and/or life cycle operations of the data (e.g., deleting older data, deleting data to keep within storage limits, etc.), for example allowing higher priority entities 111 to access shared storage resources before lower priority entities 111, allowing high priority entities 111 to keep stored data longer and/or in a higher fidelity format, and/or allowing high priority entities 111 to overwrite stored data for lower priority entities 111 when storage limits might otherwise be exceeded. Operations to remove or deprecate stored data may include, without limitation, operations such as: deleting the data, compressing the data, creating a summary or other descriptive information of the data, communicating the data to a lower capability storage of the shared data storage 300 (e.g., a slower data storage provided on the vehicle 101), and/or communicating the data to the cloud or other external storage (e.g., moving the data off-vehicle, which may render the data unavailable to on-vehicle entities but available to external devices such as for ongoing machine learning operations, and/or which may render the data available but with potential latency to access the data).

In some embodiments, the example shared data storage 300 may be a single device (e.g., embodied as the central storage 340 in the example of FIG. 15), for example a single high capacity data store that is dedicated, or having a portion dedicated, to provide storage for shared storage operations. In an example, the shared data storage 300 may include at least one shared storage location, and the at least one shared storage location may include a central storage 340 location accessed via the CCU controller and/or AP 110.

However, embodiments are not limited thereto. In certain embodiments, as illustrated by example in FIG. 15, the shared data storage 300 may be distributed across more than one device, for example utilizing all or a portion of local storage (e.g., share entity storage 311 including local storage device(s) 351) available on one or more end points (e.g., ECUs, sensors, actuators, etc.) on the vehicle 101. In certain embodiments, the shared data storage 300 may be virtually combined, for example with a logical partition of data that may include more than one physical drive location but a single addressing system utilized by the NSS server manager 140. In certain embodiments, the shared data storage 300 may embody more than one, or multiple, file systems, for example with different entities 111 utilizing the data having a mix of file storage system types.

The example end point 113 of FIG. 1—ECU 120—depicts a number of applications running thereon (e.g., App A, App B, App C, etc.). (As described by example elsewhere herein, the application(s) may be distributed across multiple end points 113.) However, the number and type of applications is a non-limiting example, and a given end point 113 may have any number of applications, or no applications. For example, an end point 113 may be a sensor that communicates information electronically to an ECU, provides information as data values to the network (e.g., to the IVN 102, or in-vehicle network, for example with a smart sensor having capability to provide direct network communications). The applications running on an end point may be part of a vehicle 101 application (e.g., the application on the end point supports an overall application for the vehicle, such as powertrain control, HVAC control, etc.), a flow (which in some examples may be described separately from an application, and may be, e.g., a related group of data or vehicle operations, where tagging and considering them together as a flow is useful for certain control operations, treatment for priority, etc.), a vehicle function, a vehicle feature, or the like. In certain embodiments, the applications running on an end point 113 may be standalone or isolated to the end point 113, where other ECUs (end points), etc., of the vehicle 101 may have no need to be aware of the existence of the application, except through interactions with the results of the application, such as utilizing data generated by the application, responding to data requests that originate within the application, etc.

In the example of FIG. 1, the NSS server manager 140 may receive—e.g., from an external entity 10-a shared storage scheme 200 that defines the storage space available, the file systems that will be supported, priority between end points, applications, flows, functions, etc., permissions for any of these, and the like, and apply that shared storage scheme 200 to the system 100. Priorities may be applied to shared data storage 300 (e.g., amount of storage available, life cycle of the data including how long it will be held, deletion order if storage is near capacity, treatment of data on deletion, etc.), supporting communications for shared data storage 300 (e.g., priority to utilize network resources to move the data within the vehicle 101, including into or out of the shared data storage 300, priority to utilize external communication resources, for example to move the data to an external entity 10 such as the cloud, etc.), and/or access to data of the shared data storage 300 (e.g., ability to read, write, edit, or delete data, as well as the ability to control which other entities can perform these operations with data that is attributed to the given entity related to the permission value). The application of permissions or priorities may be made in the context of competing entities (e.g., two end points may have a storage request, and the permissions and/or priority between those two end points may be determined based on their relative permissions or priority values), based on current operating conditions (e.g., an end point managing streaming video content may have a nominally high priority, but a lower priority during certain operating conditions such as high power output, high network utilization, low remaining shared storage capacity, etc.), based on the type of data in question (e.g., data supporting vehicle controls may have a separate, higher priority, than other data provided by a given end point, diagnostic or compliance data may similarly have a high priority, time sensitive data may have a high priority—e.g., to ensure the data is available and/or utilized within the useful time period, or a low priority—e.g., where an aspect of the capacity of the system prohibits utilizing the data in time, and therefore system resources may instead be utilized to support other data during that time period). The NSS server manager 140 may receive, as the shared storage scheme 200, a shared storage policy 220 or part of a shared storage policy 220, and then parse out the policy 220 and provide shared storage parameters 221 to each NSS client manager 150 in response to the shared storage scheme 200 and/or shared storage policy 220. In certain embodiments, the policy 220 and/or shared storage scheme 200 may include a register of entities 111 and shared storage parameters 221 for each entity 111 (e.g., shared storage available to the entity 111, network utilization for the entity 111, storage life cycle parameters, stored data utilization parameters, permissions, priority information, conditional permissions/priority information, etc.), and/or categorical shared storage parameters 221 (e.g., allowing for the determination of shared storage parameters for certain types of end points, data types, flows, applications, etc., without having to list specific end points, etc.). In certain embodiments, the policy 220 and/or shared storage scheme 200 includes a mix of entity specific shared storage parameters 221 and categorical shared storage parameters 221.

The example of FIG. 1 depicts an in-vehicle network (IVN) 102, which in some embodiments may be a single IVN and in some embodiments may be more than one IVN. In some embodiments, the NSS server manager may be communicatively coupled to the plurality of share entities 111 (e.g., end points) over the in-vehicle network (IVN) 102, and the IVN 102 may include a network switch. In some embodiments, the shared data storage 300 may be behind the network switch relative to the plurality of share entities, and the NSS server manager 140 may be further configured to manage access of the plurality of share entities to the shared data storage 300 by controlling bandwidth usage of the plurality of share entities 111 at the network switch.

The IVN 102 may include, for example, an ethernet backbone or the like. In certain embodiments, multiple networks and/or network zones may be present on the vehicle, with a converged network device (CND) or other features to pass communications between end points on different networks or network zones.

In certain embodiments, the shared data storage 300 may be communicatively coupled to an IVN 102, and end points 113 on separate networks may seamlessly access the shared data storage 300 utilizing the CND or any other supporting devices to allow communications between networks. In the example of FIG. 1, the NSS server manager 140 may perform the specific operations with the IVN 102, for example to receive data for storage and/or to provide access to stored data.

In certain embodiments, permissions, priorities, limitations due to current operating conditions, or the like, are applied before network communications are attempted by an end point 113, for example allowing the system 100 to avoid certain processing operations for network communications to implement the utilization of shared data storage 300 where the shared storage operations will not be supported. For example, an end point 113 that does not have permissions to store data in the shared data storage 300 at the moment (e.g., due to any constraint, such as limited shared storage capacity remaining, read/write throughput limitations with the physical shared storage, network communication capacity limitations, intermittent loss of communications to the cloud, a vehicle operating condition that precludes the shared storage access of the end point in question, etc.) may be instructed by the NSS client manager 150 to wait to perform the shared storage access, and/or the NSS client manager 150 waits to process the shared storage access operations, until the system 100 conditions change and the end point 113 regains permissions to access the shared data storage 300.

It may be seen that holding the shared storage access operations can greatly improve the system 100 performance, as various components of the system 100 do not have to process communications until they will be effectively acted upon by the shared storage system 100. Various processing operations for the data to be communicated can be saved, for example operations to format the data, configure the data into packets for network communications, to perform up-sampling or down-sampling operations on the data, and the like, which reduces power consumption, utilization on switches or other network components, and the like. Further, the IVN 102 (or any relevant network on the vehicle) may not have to support network communications that will not ultimately be serviced, which would otherwise utilize network capacity with useless communications, require multiple communication attempts, utilize downstream processing that would ultimately determine the data cannot be serviced at the moment, etc. Further, the end point 113 requesting the shared data storage 300 access may more rapidly respond to the momentary lack of access, allowing the requesting end point 113 to better protect critical data (e.g., prioritizing available local storage for the most important data), to send earlier notifications if some capability loss is going to occur due to the lack of shared data storage 300 access, etc. Thus, embodiments herein support not only better utilization of network and computing resources, but also support increased capability (e.g., preserving resources for serviceable data maximizes the amount of data that can be serviced), and cost reductions in supporting components (e.g., a switch throughput value can be lower if the switch services a relatively lower fraction of useless and/or repeated communications, total available data processing computing power can be reduced if the data processor services a relatively lower fraction of useless and/or repeated communications, etc.).

In example embodiments, a plurality of NSS client managers 150 may be associated with a respective plurality of share entities 111 in the vehicle 101, and an NSS server manager 140 may operate on a CCU controller (for example a controller embodying a portion, or all, of the AP controller of FIG. 1) and be communicatively coupled to the plurality of share entities 111 (e.g., over the IVN 102). The NSS server manager 140 may be configured to manage access of the plurality of share entities 111 to a shared data storage 300. For example, the NSS server manager 140 may be configured to manage access of the plurality of share entities 111 by configuring at least one of the plurality of NSS client managers 150 to manage access to the shared data storage 300. In example embodiments, the shared data storage 300 includes at least one shared storage location, and the at least one shared storage location includes a central storage 340 location accessed via the CCU controller. For example, with reference to FIG. 18, NSS server manager 140 may execute on a CCU controller, and the CCU controller may therefore provide access to the central storage 340.

Also, with reference to FIG. 18, in some embodiments, the at least one shared storage location may further include a plurality of share entity storage 311 locations at a respective plurality of at least some of the plurality of share entities 111. Data stored in the plurality of share entity storage 311 locations may be stored for a normal retention period, which may be predefined or conditional (e.g., depending on a vehicle operation or type or priority of the data, as discussed by example herein).

Also, in some embodiments, the at least one shared storage location may further include a cloud storage 332 location in an external cloud device (e.g., as part of an external entity storage 330). The cloud storage 332 location may include storage with a lower latency and storage with a higher latency. The storage with the higher latency may provide a higher compression than the storage with the lower latency and may be used for longer-term storage of data. In some examples, NSS server manager 140 may use cloud storage 332 to back up data stored on-site in the vehicle 101 (e.g., in share entity storage 311 and/or central storage 340), such as to provide redundancy for important data, and/or to move data off-site when it is likely no longer relevant to the operation of the vehicle 101.

In some embodiments, the NSS server manager 140 may be configured to store a subset of data in a plurality of shared storage 300 locations to provide redundancy for the subset of the data.

The at least one shared storage 300 location may include a buffer storage to provide temporary storage of some data. For example, the buffer storage may include a higher-speed memory. The buffer storage may be included in the share entity storage 311 of a share entity 111 or central storage 340, and with regard to its location in IVN 102, may be at a location that is quickly accessible (e.g., minimal transition points and/or travel length) by the NSS server manager 140 and/or NSS client manager(s) 150 that will be accessing the buffer storage.

In some embodiments, the NSS server manager 140 may be configured to allow an NSS client manager 150 to select an initial location from the at least one shared storage 300 location for storing data of the NSS client manager 150.

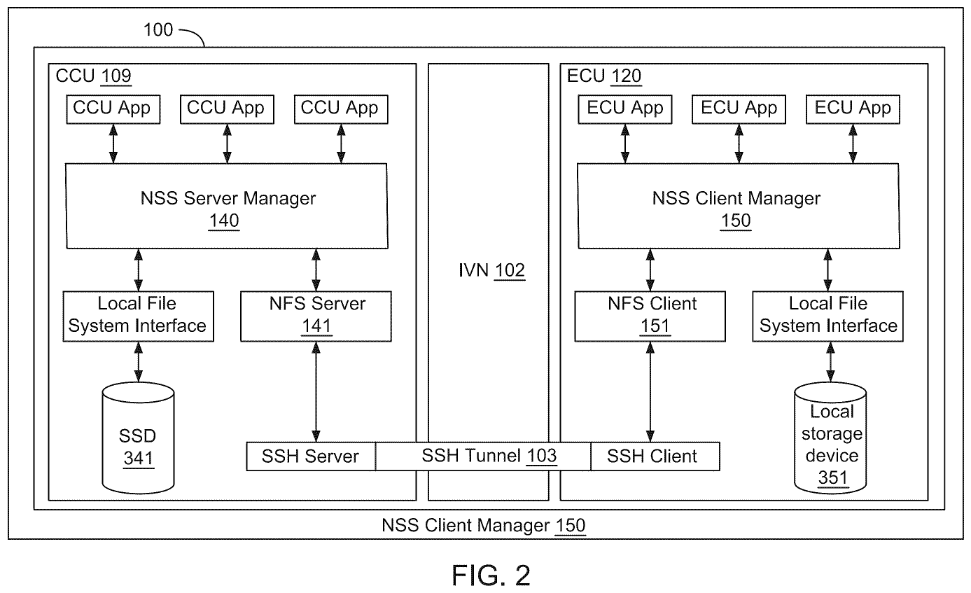

Referencing FIG. 2, a system 100 illustrating communication of shared storage messages (e.g., data paths in a network file system architecture of the system 100) is schematically depicted. The example system 100 in FIG. 2 includes an ECU controller 120, for example a controller that is part of an end point 113 of any network on the vehicle 101, and a central communication controller (CCU) controller 109, for example a controller embodying a portion, or all, of the AP controller 110 of FIG. 1. It should be noted that the CCU controller 109, the AP controller 110, or indeed any controller may be referred to interchangeably with reference to FIG. 2 provided that such a controller executes the NSS server manager 140 as described by example herein. Additionally, it should be noted that while FIG. 2 is described with reference to an ECU 120 for exemplary purposes, embodiments described with reference to FIG. 2 are not limited to ECUs 120 and may include any end point 113 as described by example herein.

In certain embodiments, there may be multiple ECU 120 controllers present. For example, each end point 113 of any network on the vehicle 101 may have an associated ECU controller 120, may be embodied (at least in part) as an ECU controller 120, and/or one or more ECU controllers 120 may provide shared storage support for one or more additional end points 113. In certain embodiments, there may be more than one CCU controller 109, and/or the CCU controller 109 may be distributed among several devices, with the distributed portions cooperating to perform the functions of the CCU controller 109.

In the example of FIG. 2, shared storage communications are passed between the CCU controller 109 (e.g., executing the NSS server manager 140) and each ECU controller 120 (e.g., executing respective NSS client managers 150) utilizing a shared storage tunnel 103, such as through the IVN 102, which may include an Ethernet network. In examples, this shared storage tunnel 103 may be encrypted via the secure shell (SSH) protocol and may be referred to as an SSH tunnel. In certain embodiments, messages may be tunneled from other networks, for example to support shared storage operations for an end point 113 on a controller area network (CAN) or other network on the vehicle 101. Example messages to support shared storage operations include, without limitation: messages including shared storage data, including data to be stored, or data being retrieved, from the shared data storage 300; policy instructions, for example from the CCU controller 109 to the ECU controller 120, including permissions, storage limits, storage formatting or protocols, etc.; message requests from the ECU controller 120 to the CCU controller 109, including permissions, requests to store, keep, or delete data, and/or requests to subscribe to stored data (e.g., from other end points 113); and/or communications from the CCU controller 109 to the ECU controller 120 to provide shared data storage 300 information (e.g., remaining data, data formatting, headers, metadata, storage protocols, etc.) and/or to provide shared data storage 300 commands (e.g., providing parsed policy instructions for the ECU controller 120, pausing, commencing, and/or modifying shared storage parameters to be utilized by the ECU controller 120, etc.). In certain embodiments, for example where the physical shared data storage memory is distributed (for example, across share entity storage 311, central storage 340, and/or external entity storage 330, as illustrated by example in FIG. 15), messages for the shared data storage 300 implementation may include information or instructions for an end point 113 contributing to the shared storage capability of the system (e.g., via its share entity storage 311), data to be stored or retrieved from the shared data storage 300, and/or targets for shared data storage 300 data transmission for storage or retrieval. For example, the CCU controller 109 may instruct a first end point 113 to provide an amount of shared data storage 300 to be reserved and/or made available for a second end point 113, with communications to the end points 113 such that they can directly communicate shared data storage data therebetween, allowing for the data to be utilized in the shared data storage 300 to be communicated on the network just one time, and without the CCU 109 controller having to process that data directly. In such embodiments, the CCU controller 109 may provide and receive further communications to support statistical analysis, monitoring, diagnostic, and/or resource management operations, for example collecting shared data storage utilization data (which may be presented as statistics with reference to the example embodiment of FIG. 17), metadata about shared data storage 300 data (as described by example elsewhere herein), the amount and/or timing of traffic on the IVN 102 to support shared data storage operations, or the like. In certain embodiments, all physical shared data storage 300 devices may be behind the CCU controller 109 (e.g., on an end point 113 with the CCU controller, such as the central storage 340, and/or utilizing off vehicle shared storage devices of an external entity 10), relative to the network 102, and shared data storage 300 data storage and retrieval operations may be processed by the CCU controller 109. It should be understood that the above description's reference to operations of the CCU controller 109 may refer to execution of the NSS server manager 140 on the CCU controller 109, and that reference to operations of the ECU controller 120 may refer to execution of the NSS client manager 150 on that ECU controller 120.

Operations of example embodiments herein, for example utilizing the parsed policy instructions provided to the NSS client manager 150 from the NSS server manager 140, may screen communications that will not be implemented, for example due to permissions, shared storage limitations, due to network bandwidth management, or the like, such that the CCU controller 109 may not have to process communications that are not consistent with the present limitations of the operating system and/or that will otherwise not be implemented at the current time.

Examples of the present disclosure may refer to an ethernet network as at least part of the IVN 102 for clarity of the description. However, end points 113 on any network can be configured to benefit from the shared data storage 300 operations of embodiments herein. Further, as described by example herein, end points 113 utilizing shared data storage 300 operations may be on distinct network zones, types of networks, networks utilizing different protocols, etc. Additionally, certain aspects of embodiments of the present disclosure include adjusting the routing of communications on a network 102, whether between separate devices on the network, or between a device on the network and an external device/external entity 10. Without limitation to any aspect of the present disclosure, some tools that can be utilized to tactically implement certain operations herein, in combination with the present disclosure, and descriptions that can enhance understanding of some of the terminology used herein (e.g., policy, end point, external device, network protocol, network type, etc.) may be found in one or more of the following U.S. Patents or Patent Applications: U.S. application Ser. No. 17/027,167, filed 21 Sep. 2020, and entitled SYSTEM, METHOD, AND APPARATUS TO SUPPORT MIXED NETWORK COMMUNICATIONS ON A VEHICLE (SONA-0006-U01); U.S. application Ser. No. 17/027,187, filed 21 Sep. 2020, and entitled SYSTEM, METHOD, AND APPARATUS TO EXTRA VEHICLE COMMUNICATIONS CONTROL (SONA-0007-U01); U.S. application Ser. No. 17/195,589, filed 8 Mar. 2021, and entitled SYSTEM, METHOD, AND APPARATUS FOR MANAGING VEHICLE DATA COLLECTION (SONA-0010-U01); U.S. application Ser. No. 17/833,614, filed 6 Jun. 2022, and entitled SYSTEM, METHOD, AND APPARATUS FOR MANAGING VEHICLE DATA COLLECTION (SONA-0012-U01); and/or U.S. application Ser. No. 18/244,147, filed 8 Sep. 2023, and entitled SYSTEM, METHOD, AND APPARATUS TO EXECUTE VEHICLE COMMUNICATIONS USING A ZONAL ARCHITECTURE (SONA-0015-U01), each of which is incorporated herein by reference in the entirety for all purposes.

In example embodiments, the NSS server manager 140 may be communicatively coupled to a plurality of share entities 111 over a mixed in-vehicle network (IVN) 102 including a plurality of different network types. As described by reference to example embodiments herein, IVN 102 may include, for example, an ethernet backbone or the like. In certain embodiments, multiple networks and/or network zones may be present on the vehicle, with a converged network device (CND) or other features to pass communications between end points on different networks or network zones. In some embodiments, the plurality of different network types may include a Controller Area Network (CAN) based network and an Ethernet based network. Further, the IVN 102 may include a configurable edge gateway (CEG) configured to access the CAN based network and an Ethernet switch configured to access the Ethernet based network. The NSS server manager 140 may be configured to facilitate communications between this plurality of different network types.

As described by example elsewhere herein, the plurality of share entities 111 in some embodiments may include a plurality of end points 113 of the vehicle 101. In some examples, the plurality of end points 113 may include at least one of an electronic control unit (ECU), a controller, a smart sensor, or a smart actuator, and/or at least one of an application or a flow distributed across multiple ones of the plurality of end points 113 and managed by an NSS client manager 150 associated with the at least one of the application or the flow.

In some embodiments where the IVN 102 includes a CEG, the NSS server manager 150 may be configured to instruct the CEG to route data between the plurality of different network types according to at least one of a priority, a utilization, an operating condition, or a current storage status of the shared data storage 300.

In some embodiments, as an example, the NSS server manager 140 (and/or an NSS client manager 150) may be configured to capture an initial Ethernet message from one of the plurality of share entities 111 on the Ethernet based network, convert the initial Ethernet message to compliant CAN message information, and package the compliant CAN message information into an Ethernet message to store the compliant CAN message information in the shared data storage 300. The compliant CAN message information may include information to build a compliant CAN message, and/or may include the compliant CAN message itself. Thus, the NSS server manager 140 and/or NSS client manager 150 may be able to convert the compliant CAN message information to a CAN message for providing to a CAN-based end point 113 on a CAN network of the IVN 102. And in some embodiments, the NSS server manager 140 may be configured to, upon request from a requesting entity (e.g., such as an external device 10), unpackage the compliant CAN message information from the shared data storage 300 and provide the compliant CAN message information to the requesting entity.

In some embodiments, as an example, the NSS server manager 140 may be configured to receive a CAN message from the CAN based network, and package the CAN message into an Ethernet message for storing in the shared data storage 300. The NSS server manager 140 may process the CAN message according to at least one of a sampling rate, a resolution, or units associated with the CAN message, and may package the CAN message with information regarding the at least one of the sampling rate, the resolution, or the units.

In some embodiments, where the plurality of different network types includes a CAN network and the plurality of share entities 111 includes a CAN end point 113 such as a CAN electronic control unit (ECU) with a respective one of the plurality of NSS client managers 150 associated therewith, the respective one of the plurality of NSS client managers 150 may communicate with the NSS server manager 140 on behalf of the CAN ECU over the CAN based network. This respective one of the plurality of NSS client managers 150 may be configured to interpret communications between the CAN ECU and the NSS server manager 140, the plurality of share entities 111, and the shared data storage 300. Thus, the NSS client manager 150 may effectively serve as a “guardian” for the CAN end point 113 (such as a CAN ECU), communicating with the NSS server manager 140 and other components on behalf of the CAN end point 113. For example, the CAN end point 113 on its own may not be capable of using the shared data storage 300, but, for example, may simply be capable of asking for data and sending data. The NSS client manager 150 associated with the CAN end point 113 (or the NSS server manager 140) may therefore interpret requests from the CAN end point and package them in a manner interpretable by other end points. Likewise, the NSS client manager 150 associated with the CAN end point 113 may respond to its requests and send data to the CAN end point 113 in a manner that the CAN end point 113 can accept. For example, the NSS client manager 150 may convert data sizes, data types (e.g., float versus integer), and attend to other packaging requirements so that the CAN end point 113 receives data in a format that it can understand. Additionally, the NSS client manager 150 may manage connections between the CAN end point 113 and other end points 113, the NSS server manager 140, and/or an external entity, since the CAN end point 113 itself may not be capable of establishing a connection (e.g., via a handshake) or detecting the failure thereof. Thus, the NSS client manager 150 may manage connections for the CAN end point 113, including performing retries and timeouts when a connection fails, and buffering appropriate amounts of data from the CAN end point 113 in the event of a connection failure (e.g., due to EMI). (In some embodiments, this buffering may utilize buffer storage as described by example elsewhere herein.) For example, the NSS client manager 150 may buffer data corresponding to greater than or equal to a realistically possible connection failure duration caused by EMI.

As a specific example of an NSS client manager 150 serving as the gateway or “guardian” for its associated CAN end point 113 may receive a request from the CAN end point 113 for ambient temperature. The NSS client manager 150 may have knowledge of responses to the CAN end point 113 requests that the CAN end point 113 is capable of understanding. For example, the CAN end point 113 may be capable of receiving a CAN-specific message (e.g., a code) indicating, for example, that no temperature is available, and the NSS client manager 150 may send such a message to the CAN end point 113 upon such a request.

In some embodiments, the NSS server manager 140 may manage data from the plurality of share entities 111 according to a data policy (e.g., as described by example herein, and which may be included in a shared storage policy 220 and/or shared storage scheme 200) that specifies moving the data from a first portion of the shared data storage 300 to a second portion of the shared data storage 300 over a lifetime of the data. For example, the second portion of the shared data storage 300 may be in a location that takes longer to access (e.g., due to its physical location on the IVN 102), and/or may provide a lower-speed, higher-reliability memory more suitable to long-term storage.

In some embodiments, the NSS server manager 140 may manage data from the plurality of share entities 111 according to a data policy that includes a redundancy description that specifies types of data to be stored redundantly. For example, the redundancy description may indicate a first type of data to be stored in a physically redundant manner, where the first type of data is critical data (for example, data critical to operation of the vehicle). Further, the redundancy description may indicate a second type of data to be stored to provide control redundancy, where this second type of data may be accessible by a plurality of electronic control units (ECUs) or other end points 113. Also, the redundancy description may indicate a specific location of the shared data storage 300 to store the first type of data in the physically redundant manner. This specific location of the shared data storage 300 may be at a different end point 113 than a first location of the shared data storage 300 at which the first type of data is stored. For example, the different end point 113 may be in a physically distinct location of the vehicle as a precaution in the event of a catastrophic failure at the first location.

In some embodiments, the mixed IVN 102 may include a network switch as discussed by example herein, and the shared data storage 300 may be behind the network switch relative to the plurality of share entities 111, and the NSS server manager is further configured to manage access of the plurality of share entities 111 to the shared data storage 300 by controlling bandwidth usage of the plurality of share entities 111 at the network switch.

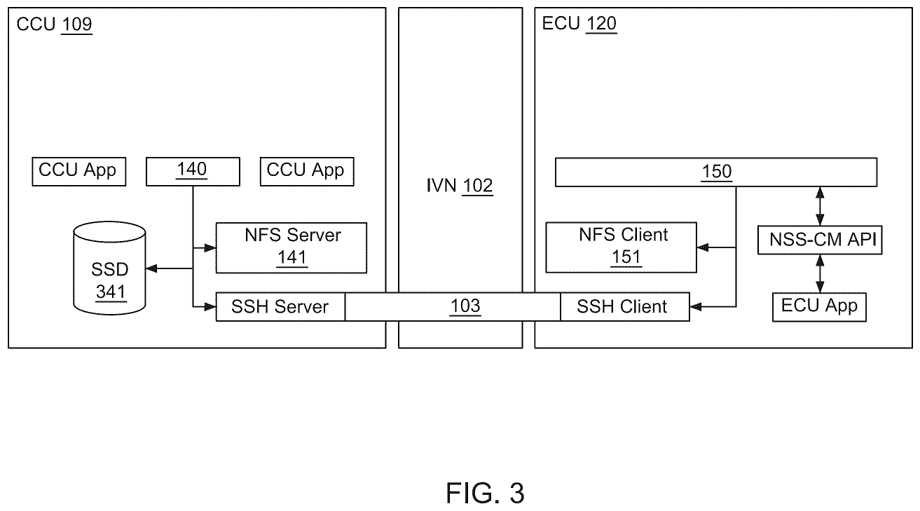

Referencing FIG. 3, shared data storage 300 control communications may be passed between the CCU controller 109 (e.g., executing NSS server manager 140) and each ECU controller 120 or other end point 113 (e.g., executing respective NSS client managers 150) utilizing a shared storage tunnel 103, which may be through an ethernet network in the example of FIG. 2. In the example of FIG. 3, the network shared storage (NSS) server manager 140 and the network shared storage (NSS) client managers 150 (also reference FIG. 1) may manage the shared data storage 300 control. The NSS server manager 140 may receive and parse a policy (e.g., a shared storage policy 220 that may be part of a shared storage scheme 200) that sets forth the parameters for shared data storage 300 operation, including how much storage each device (e.g., end point 113) is permitted to utilize, network bandwidth utilization allowable to support shared data storage operations, priority between devices for shared data storage utilization and/or bandwidth utilization, and any competing conditions or operating conditions that may affect these. For example, a given device may have a first priority value for a first operating condition (e.g., idle operation, shutdown operations, low power operation, etc.) and a second priority value for a second operating condition (e.g., high power operation, startup operations, high network bandwidth utilization, etc.). The control parameters may allow for an external entity 10 such as a user (e.g., an owner, operator, service person, dealer, manufacturer, etc.) to provide for a shared data storage 300 solution for the vehicle 101 that results in many of the benefits and technical improvements set forth herein—for example, enabling the utilization of lower cost controllers for many of the end points 113 of the vehicle 101, improving network utilization (e.g., allowing for the time shifting of some data sharing operations between end points and/or with the cloud to a “lower cost” operating time, for example allowing for peak operations to have a relatively lower peak, or highest bandwidth, and/or reducing the required capability for the entire network and/or components thereof). In combination with certain other features, such as features that allow an external user to readily prepare data collection operations, configure automated vehicle functions and responses, and/or implement automated testing and/or diagnostic operations, embodiments herein overcome additional challenges in previously known systems, for example allowing data related to diagnostics, testing, fault tree analysis, deep learning algorithms, or the like, to be readily generated and stored by any end point 113 in the system 100, for example allowing the capture of data from a device that provides critical data but that does not inherently have large local storage otherwise available to the device (e.g., a key sensor, logic circuit, etc., in the system 100, and/or any other controller having sufficient local storage to perform its own functions, but not to support other aspects of the system 100 that may not even be known at the time that the controller is designed and/or purchased). The communication of shared data storage 300 control communications, such as depicted in FIG. 3, may be performed at any time—for example after a policy is received and validated, at vehicle startup, at vehicle shutdown, during certain operating conditions (e.g., detection of an extended idle period), periodically (e.g., once per day, once per trip, once per week, etc.), and/or any combination of these. The communications may be scheduled such that operations do not interfere with vehicle operations, and/or such that operations will be expected to succeed (e.g., the available network bandwidth, processor duty cycles, etc., are expected to be sufficient and for a sufficient period of time to complete the control communication and/or server/client manager reconfiguration operations).

Accordingly, the timing and/or methodology of updates may depend upon the type of update being performed, the end points 113 that are involved in the update, relevant time factors for the update (e.g., time value and/or urgency of the reconfiguration operation, where the urgency may be indicated in the policy that implements the update; normal drive cycle for the vehicle by time, date, day of the week, etc.; expected amount of time that relevant vehicle operations are expected to continue, etc.). In certain embodiments, similar considerations for the timing of shared data storage 300 NSS server manager 140 reconfiguration operations may apply. For example, the shared data storage 300 server manager 140 may provide a number of available file systems that may be utilized by end points 113 utilizing the shared data storage 300, where certain operations such as adjusting partition sizes, formatting portions of the shared storage memory, creating or deleting partitions, etc., may be performed at times where the operation will have sufficient time to succeed and will not interrupt the vehicle 101 operations. In certain embodiments, portions of critical files, such as the policy, parsed elements from the policy, memory locations related to critical operating system files, or the like, may be updated by creating a second version, allowing all of the reading, writing, formatting, and the like to be completed before direct utilization, and then swapping to the reconfigured elements once they are ready. These swapping operations may be performed piece-wise (e.g., reconfiguring portions of the shared data storage 300, for example to allow fully protected reconfiguration operations without having to mirror the entire system, which could potentially double the memory utilization), and/or may be performed as a hot swap operation where the change to utilize the reconfigured shared storage scheme 200 is executed during run time, allowing for immediate implementation of the updates, and avoiding a situation where a vehicle operates for an extended period and does not receive an update due to restart conditions being unavailable.

In example embodiments, an NSS server manager 140 may be communicatively coupled to a plurality of share entities 111 and configured to manage access of the plurality of share entities 111 to a shared data storage 300, including managing a partitioned file system on the shared data storage 300. The NSS server manager 140 may be configured to manage access of the plurality of share entities 111 by configuring at least one of the plurality of NSS client managers 150 to manage access to the partitioned file system on the shared data storage 300 by an associated one of the respective plurality of share entities 111.

In some embodiments, the partitioned file system includes a plurality of partitions of the shared data storage 300 allocated by the NSS server manager 140 to respective ones of the plurality of share entities 111.

In some examples, the associated one of the respective plurality of share entities 111 includes at least one of the partitions of the shared data storage 300. At least one of the plurality of partitions may include folders accessible for storage by one or more of the plurality of share entities 111. At least one of the plurality of partitions may be virtual and include multiple physical storage locations including at least one of: a central shared storage 340 location associated with the NSS server manager 140 (see, e.g., FIG. 18), a distributed shared storage 311 location at one or more of the share entities 111, or a cloud storage 332 location. At least one of the NSS client managers 150 may be configured, by the NSS server manager 140, to permit only read-only access to at least one of the plurality of partitions by the associated one of the respective plurality of share entities 111.

In some embodiments, the NSS server manager 140 may monitor storage statistics of the shared data storage 300 to provide to an external entity 10 such as an external device. For example, the NSS server manager 140 may provide the statistics to the external device via a user interface 501 (see FIG. 17) configured to be displayed on a display 500 of the external device 10 or otherwise associated with the external device 10. In an example, the statistics may include at least one of utilization of the shared data storage 300, free space of the shared data storage 300, fragmentation of the shared data storage 300, or diagnostics of the shared data storage 300.

In some embodiments, the NSS server manager 140 or the at least one of the plurality of NSS client managers 150 may provide encryption for at least one partition or folder of the shared data storage 300. For example, the NSS server manager 140 may provide encryption for at least one partition or folder of the shared data storage 300 that corresponds to the central storage 340, and the at least one of the NSS client managers 150 may provide encryption for at least one partition or folder of the shared data storage 300 that corresponds to a share entity storage 311 with which the NSS client manager 150 is associated (or, alternatively, the NSS server manager 140 may provide this encryption).

In some embodiments, the associated one of the respective plurality of share entities 111 may include a long-term storage, and the at least one NSS client manager 150 may be configured to store redundant data (e.g., as described with reference to example embodiments herein) on the long-term storage of the associated one of the respective plurality of share entities 111.

In some embodiments, the plurality of share entities 111 may include a plurality of end points 113 of the vehicle 101, as may be described with reference to example embodiments herein, and the plurality of end points 113 may include at least one of an application or a flow distributed across multiple ones of the plurality of end points 113 and managed by an NSS client manager 150 associated with the at least one of the application or the flow.

In example embodiments, the NSS server manager 140 may be configured to manage access of the plurality of share entities 111 by configuring at least one of a plurality of NSS client managers 150 to manage access to the shared data storage 300 by an associated one of the respective plurality of share entities 111 based on a memory identification provided by the NSS server manager 140. Additionally, in an example, the NSS server manager 140 may indicate a size of the shared data storage 300 available to the associated one of the respective plurality of share entities 111.

In some embodiments, this memory identification may include at least one memory address of the shared data storage 300 to which the associated one of the respective plurality of share entities has access. And, for example, the at least one of the plurality of NSS client managers 150 may access the shared data storage 300 for the associated one of the respective plurality of share entities 111 using the at least one memory address. Indeed, the at least one of the plurality of NSS client managers 150 may be location-agnostic in terms of this access, and may access the shared data storage 300 without regard to a location of the shared data storage 300 at the at least one memory address. For example, with reference to FIG. 15, the memory address may reference a location on at least one of the share entity storage 311, the external entity storage 330, or the central storage 340. In an example, the at least one memory address may include an indication of a block of memory to which the associated one of the respective plurality of share entities 111 has access.

In some embodiments, the memory identification may include a metadata name for the shared data storage 300 available to the associated one of the respective plurality of share entities 111.

Thus, in example embodiments, the system 100 including the shared data storage 300 may provide access to the shared data storage 300 using memory identification rather than a formal file system including partitions and/or folders. Instead, it may be up to the NSS client managers 150 to manage their access to the shared data storage 300 to which they have access, which may be provided to them simply with an identification (e.g., an address or an address block) and an indication of the amount of space available, e.g., by developing their own manner of organizing their data in the shared data storage space allocated to them.

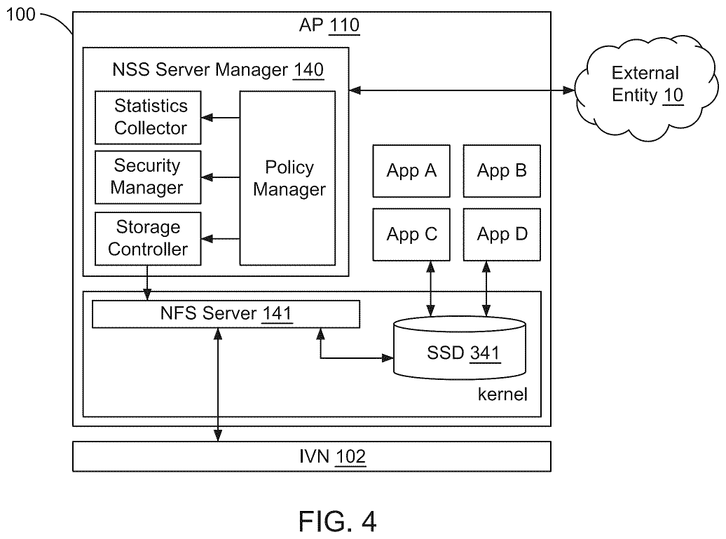

Referencing FIG. 4, a schematic detail of an example shared storage controller (e.g., an AP controller 110 and/or CCU controller 109, which may execute NSS server manager 140) is depicted. The storage controller, and in some examples more specifically the NSS server manager 140, may control operations of various storage devices (e.g., database, file system, and object store servers); the security manager reports and acts on any situation that may be an indication of potential malicious activity; the policy manager receives and processes new policies, policy updates, or other shared data storage descriptions, including verifying, parsing, and distributing the policies and/or relevant portions thereof; and the statistics collector collects statistics related to the shared data storage operations, such as utilization, event logs, etc. As described with reference to FIG. 17, such statistics may be presented to an external entity via a user interface 501.

Example and non-limiting statistics that may be collected include any statistics related to the execution and performance of the shared data storage operations, utilization of processor and/or networking resources to support the shared data storage operations, and/or utilization of shared data storage resources, including tracking whether share entities 111 having shared data storage resources (e.g., end points, controllers, circuits, flows, applications, etc.) have sufficient storage resources dedicated to those share entities 111, and/or are utilizing the storage resources dedicated to those share entities 111. Example and non-limiting statistics that may be collected include any one or more of: packet statistics (e.g., number of packets received, dropped packets, packet types, number of TCP connections); remote procedure call statistics (e.g., the number of sent calls, bad calls, malformatted calls, calls without proper authorization, etc.); storage I/O statistics (e.g., number of reads and/or writes); system status (e.g., whether the shared data storage 300 is operable, logs, events, faults, etc.); share information (e.g., a share identifier, display name, share size, used space, free space, mount location(s), mount active descriptor or Boolean, directories, and/or exports); directory information (directory name, directory path, user owner, and/or group owner); export information (e.g., location, options); physical storage statistics (e.g., hardware version, firmware version, warnings or logs, power cycles, data write cycles, errors, temperature events, etc.); and/or client statistics (e.g., client address, mount points, read/write operation statistics, etc.). The statistics may be stored, accessed, and/or communicated to an external entity 10 according to a schedule, in response to events (e.g., detection of an error, an unavailable shared storage for a share entity 111, etc.); and/or upon request (e.g., by a user from an external device, such as may be displayed via a user interface 501). The statistics information may be stored, accessed, and/or communicated using any data format. In certain embodiments, the statistics may be packed into a JSON format which is then sent to an external device and/or stored locally before sharing. An example JSON format for statistical information is schematically depicted following:

Example JSON formatted statistical information:
{
   “packetStats”: {“packets”:{
   “10”,
   “udp”: “0”,
   “tcp”: “43878”,
   “tcpcon”: “2”
   },
   “rpcStats”:{
   {“calls”:
   “10”,
   “badCalls”: “0”,
   “badFmt”: “4”,
   “badAuth”: “2”,
   “badClnt”: “0”
   },
   “ioStats”:{
   “read”:
   “600”,
   “write”: “490”,
   },
   “systemStatus”:{
   “nfsRunning”: true,
   “main_volume_operational”: true,
   “shares”: [
   {
   “uuid”: “xih1b8-aslm-Quxz-kNVn-MKsB-L6b2-QcYjyi”,
   “name”: “DFJ9LK”,
   “status”: “available”,
   “size”: 2411724800,
   “usedSpace”: 3445555,
   “freeSpace”: 8798374,
   “encrypted”: false,
   “mount_point”: “/mnt/dlt”,
   “is_mounted”: true,
   “directories”: [
      {
      {“name”:
      “dlt-ccu”,
      “path”: “/mnt/dlt/dlt-ccu”,
      “user_owner”: “usr_dlt-ccu”,
      “group_owner”: “grp_dlt”
      },
      {
      “name”: “dlt-dcu”,
      “path”: “/mnt/dlt/dlt-dcu”,
      “user_owner”: “usr_dlt-dcu”,
      “group_owner”: “grp_dlt”
      }
   ],
   “exports”: [
      {
      “ip_addr”: “10.0.64.0”,
      “options”:
“(rw,wdelay,root_squash,no_subtree_check,see=sys,rw,secure,root_squash,no_all_squash)”
   },
   {
   “ip_addr”: “10.16.0.0”,
   “options”:
“(rw,wdelay,root_squash,no_subtree_check,see=sys,rw,secure,root_squash,no_all_squash)”
   }
   ]
   }
   ]
   },
   “nvmeStats”: {
   “node”:“/dev/nvme0n1”,
   “serialNumber”: “21172E7B61AE”,
   “model”: “MTFDHBL064TDQ”,
   “namespaceID”: “ffffffff”,
   “firmwareRev”: “MU01.1”,
   “criticalWarning”: 0,
   “temperature”: “56 C”,
   “availableSpare”: “100%”,
   “availableSpare Threshold”: “10%”,
   “percentage_used”: “1%”,
   “enduranceGroupCriticalWarningSummary”: “0”,
   “dataUnitsRead”: “1920381”,
   “dataUnitsWritten”: “3018381”,
   “hostReadCommands”: “5558934”,
   “hostWriteCommands”: “9276754”,
   “controllerBusy Time”: “1514”,
   “powerCycles”: “319857”,
   “powerOnHours”: “7383”,
   “unsafeShutdowns”: “319785”,
   “mediaErrors”: “0”,
   “numErrLogEntries”: “0”,
   “warning Temperature Time”: “0”,
   “criticalComposite Temperature Time”: “0”,
   “temperatureSensor 1”: “51 C”,
   “thermalManagementT1TransCount”: “0”,
   “thermalManagementT2TransCount”: “0”,
   “thermalManagementT1TotalTime”: “0”,
   “thermalManagementT2TotalTime”: “0”
   },
   “clients”: [
   {
   “clientIP”: “10.0.64.0”,
   “mountPoints”: [
   }
      “share”: “10.0.6.0:/mnt/adasvp”,
      “mountPoint”: “/home/appl/TEST”,
      “ops/s”: “6.000”,
      “rpcBklog”: “0.000”,
      “readOps/s”: “0.000”,
      “readKB/s”: “0.000”,
      “readKB/op”: “0.000”,
      “readRetrans”: “0 (0.0%)”,
      “readAvgRTT (ms)”: “0.000”,
      “readAvgExe (ms)”: “0.000”,
      “writeOps/s”: “0.000”,
      “writeKB/s”: “0.000”,
      “writeKB/op”: “0.000”,
      “write Retrans”: “0 (0.0%)”,
      “writeAvgRTT (ms)”: “0.000”,
      “write AvgExe (ms)”: “0.000”
   }
   ]
   }
   ]
}

The example system 100 may enforce security for the data, files, and directories on the system. Each file and directory includes an authorization description listing share entities 111 on the system that are authorized to read, write, and/or execute files or directories. Read permission allows the share entity 111 to read the contents of a file (e.g., read stored data) or directory. Write permission allows the share entity 111 to modify or delete files, or to create new files in a directory. Execute permission allows the user to execute the file (e.g., as a script), and/or to navigate a directory. The example permissions scheme is non-limiting, and additional permissions may be provided, and/or a more complex permissions arrangement may be provided. For example, separate permissions may provide the ability to append data to a file, but not to delete or modify contents of the file; provide the ability to create new files, and/or provide the ability to command compression of data (including, for example, distinct permissions for lossless or lossy compression, etc.). The permissions are related to share entities 111 in the system 100, where the share entity 111 may be an end point, a client manager, an application, a flow, a controller, a circuit, or the like. In certain embodiments, permissions are managed at the NSS client manager 150 level, with the permissions associated with applications running on the controller including the NSS client manager 150. In certain embodiments, any permissions organization or hierarchy may be selected, for example with individual applications having distinct permissions, even where those applications are serviced by a same NSS client manager 150. In certain embodiments, groups of individual applications may have shared permissions, or partially shared permissions, where the groups may be serviced by a same NSS client manager 150, and/or distributed on several end points and/or serviced by more than one NSS client manager 150.

In certain embodiments, permissions for entities and/or groups are provided in the policy 220. In certain embodiments, a default permission for entities and/or groups may be utilized, for example where a policy 220 is silent on the permissions for a particular entity or group. In a further example, as a default permissions setting, entity owners and/or group owners are given read and execute access to a directory, and entity owners have write access, but group owners do not. In a further example, other entities or groups do not have any permissions, in the absence of an explicit permission in the policy 220.

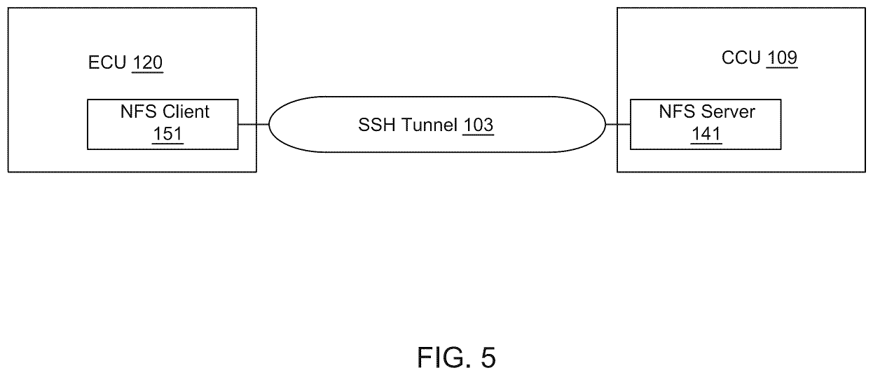

In certain embodiments, shared storage related communications are all passed through the shared storage tunnel 103, which may use the secure shell protocol (SSH) (e.g., reference FIG. 5) and may be referred to herein as an SSH tunnel, and accordingly all participants (e.g., NSS client managers 150) in the shared (data) storage system 100 may be required to authenticate through the SSH. In certain embodiments, implementation with the SSH includes encrypting all packets of shared data storage 300 related communications. In certain embodiments, the SSH server (e.g., the SSH server on the AP controller 110 and/or CCU controller 109) may prohibit shell access to all entities 111. For example, entities 111 that connect through the SSH tunnel 103 may only be permitted to do port forwarding from the ECU 120 (or NSS client manager 150) that manages connections for that entity 111. In certain embodiments, all shared data storage 300 data is encrypted at rest, but this may be specified in the policy 220. In certain embodiments, all shared data storage 300 data may utilize a same encryption key, which may be stored in a secure location (e.g., on the AP controller 110), but this may be specified in the policy 220. In certain embodiments, different types of data in the shared data storage 300 may utilize a different encryption key, for example using separate encryption keys for control data, audiovisual data, historical performance data, etc. In certain embodiments, unique encryption keys for the vehicle 101 are set on the first time the AP 110/CCU 109 controller is booted, and may be reset periodically, and/or upon request or instruction. In certain embodiments, for example where an encryption key is erased or lost (e.g., due to a corruption error), then the shared data storage 300 will be deleted, new key(s) generated, and the shared data storage 300 will be recreated.

In certain embodiments, network bandwidth management may be controlled explicitly (e.g., the SSH/NFS server limiting the communications allowed to support shared storage operations) and/or implicitly (e.g., in many systems, the processor utilization for SSH operations will correlate with network bandwidth utilization, and accordingly, by managing the processor utilization to service SSH operations, the network bandwidth utilization will be similarly managed. In certain embodiments, SSH/NFS server operations may be performed with a limited number of processes (or just one process) with a low priority value to limit processor utilization from the operating system scheduler.

In certain embodiments, policy management operations include determining whether a policy 220 is applicable, for example validating that the policy 220 is compatible with the current state of the vehicle 101 and the computing system. Example checks to validate the policy and/or determine whether the policy 220 is applicable include operations such as: determining that the policy format is readable and properly configured; determining that fields in the policy 220 are consistent with the expected schema; determining that field values are properly set (e.g., within expected or allowed value ranges, correlations between values are consistent, etc.); determining that implementation of the policy 220 will exceed a system limitation such as available storage on a partition of the shared data storage 300; and/or determining that implementation of the policy 220 will result in a data corruption of data within a share (e.g., due to reserved share size). In certain embodiments, the policy 220 may be further classified by the type of operations indicated by the policy 220, for example to schedule policy response and implementation operations. For example, a first policy class (e.g., class A) may be determined if the policy 220 involves the modification of any logical volume, for example creating a new share, deleting an existing share, resizing an existing share, encrypting an existing share, or decrypting an existing share. In a further example, a second policy class (e.g., class B) may be determined if the policy 220 is not already class A, and if the implementation of the policy 220 would disrupt any service for an entity (or group) within the system, for example if the policy 220 removes an entity 111 from the shared storage system 100, removes a permission from an entity 111, and/or removes a folder from a share. In a further example, a third policy class (e.g., class C) may be determined if the policy is valid (or applicable) but is not of either class A or class B.

In certain embodiments, the implementation of a policy 220 can be made in any manner, but may include scheduling the implementation by considering the class of the policy 220. An example implementation of a policy class A includes setting a parameter indicating that the policy 220 is applicable/validated, but has not yet been applied, applying the policy to a backup partition, verifying that the backup partition is consistent with the active partition, maintaining consistency between the backup partition and the active partition until the policy 220 is implemented, and maintaining a zero difference between the backup partition and the active partition at each power down and power up cycle. The example implementation further includes swapping the active and backup partitions at a time when the zero difference is applicable and no entities are being actively serviced for shared storage operations. The example implementation concludes with setting a parameter indicating that the policy 220 has been applied. In certain embodiments, implementation of a class A policy may involve several power cycles of the AP/CCU controller before the implementation is completed.

An example implementation of a class B policy 220 includes setting a parameter indicating the policy 220 is applicable, applying the policy 220 at a next power on cycle for the AP 110/CCU 109 controller, and setting a parameter indicating the policy 220 has been applied. An example implementation of a class C policy includes implementing the policy immediately after determining the policy 220 is applicable, and setting a parameter indicating the policy 220 has been applied. In certain embodiments, the parameter indicating the policy status (e.g., applicable, and/or applied) is provided to the policy manager, provided to an external device, and/or stored for monitoring access. In certain embodiments, specific situations for applying a policy 220 may utilize a distinct implementation, for example a policy 220 applied during manufacture, body building operations, service operations, vehicle upfit operations, etc., may be applied differently, and/or immediately. In certain embodiments, application of a policy 220 in a specific situation may be determined from data within the policy 220, based on the providing entity for the policy 220, based on the external device providing the policy 220, or the like.

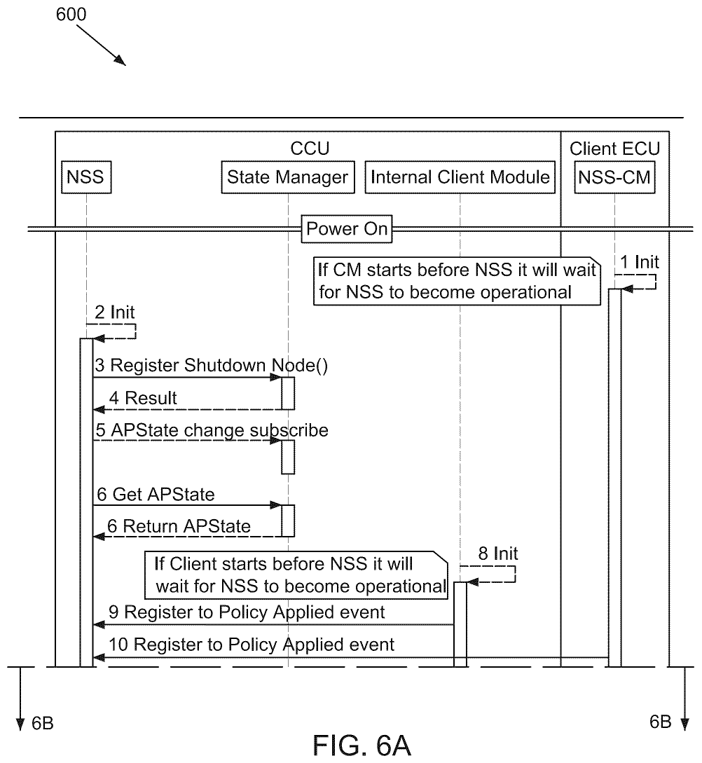

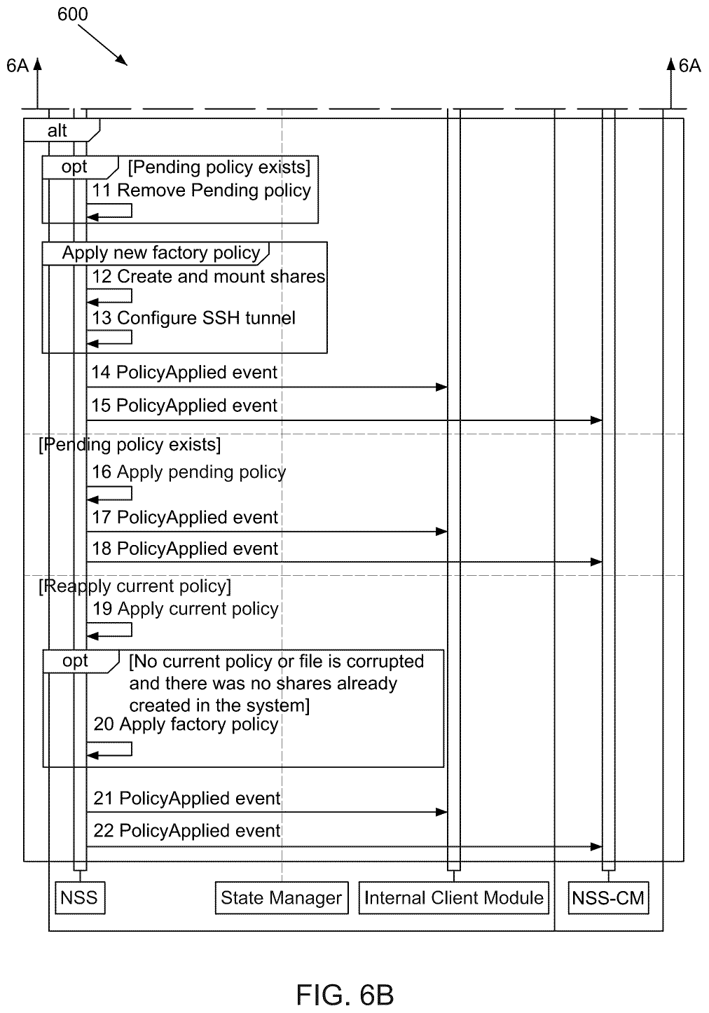

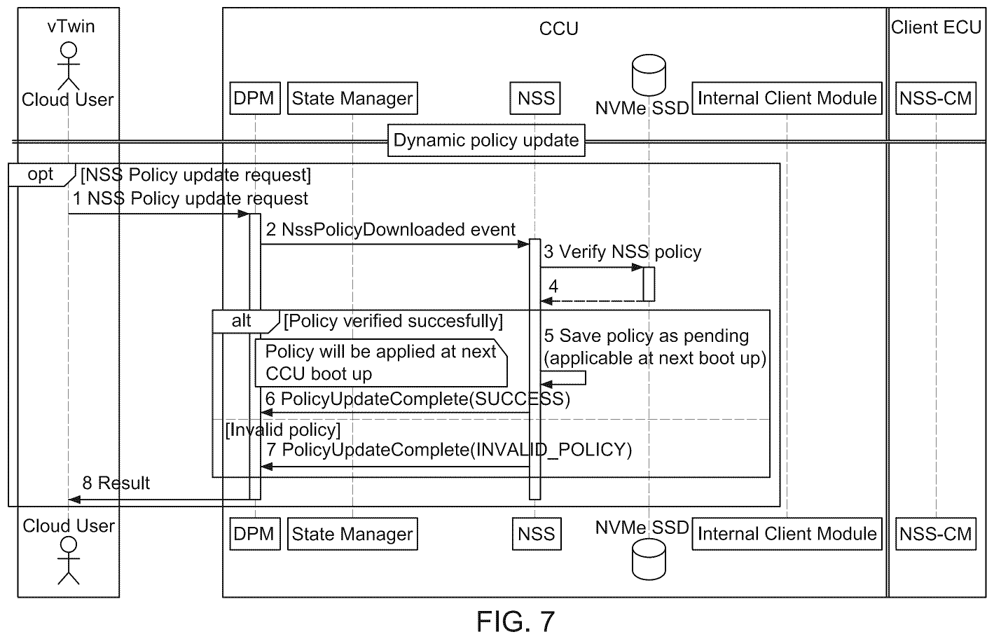

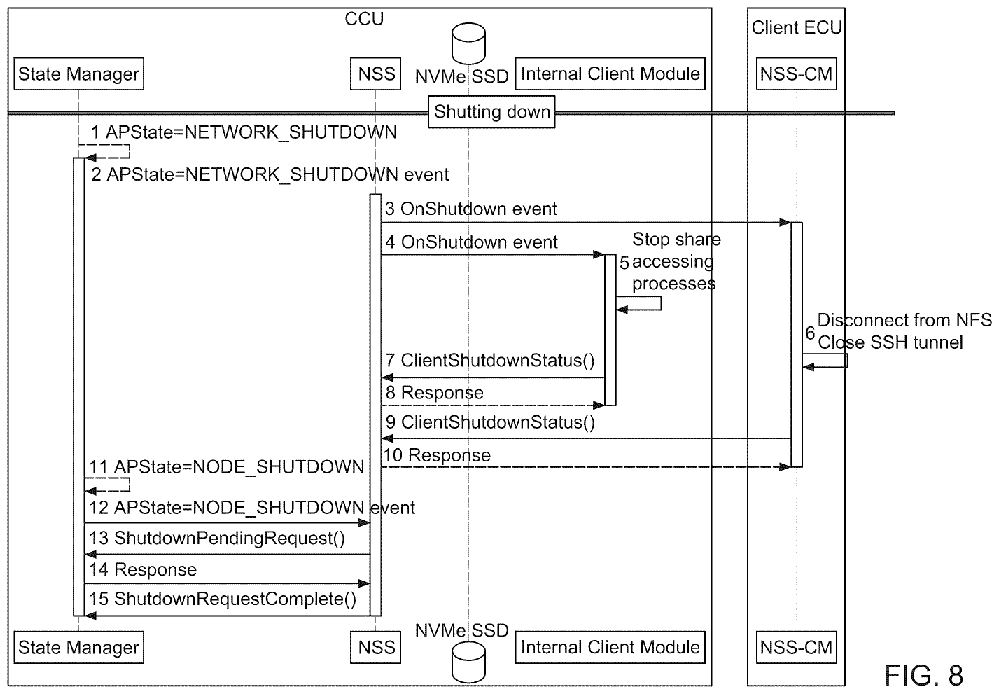

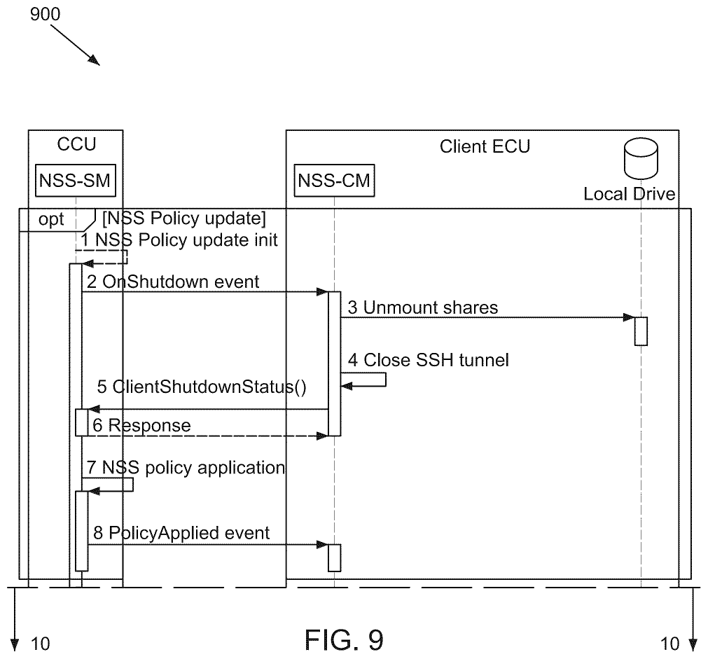

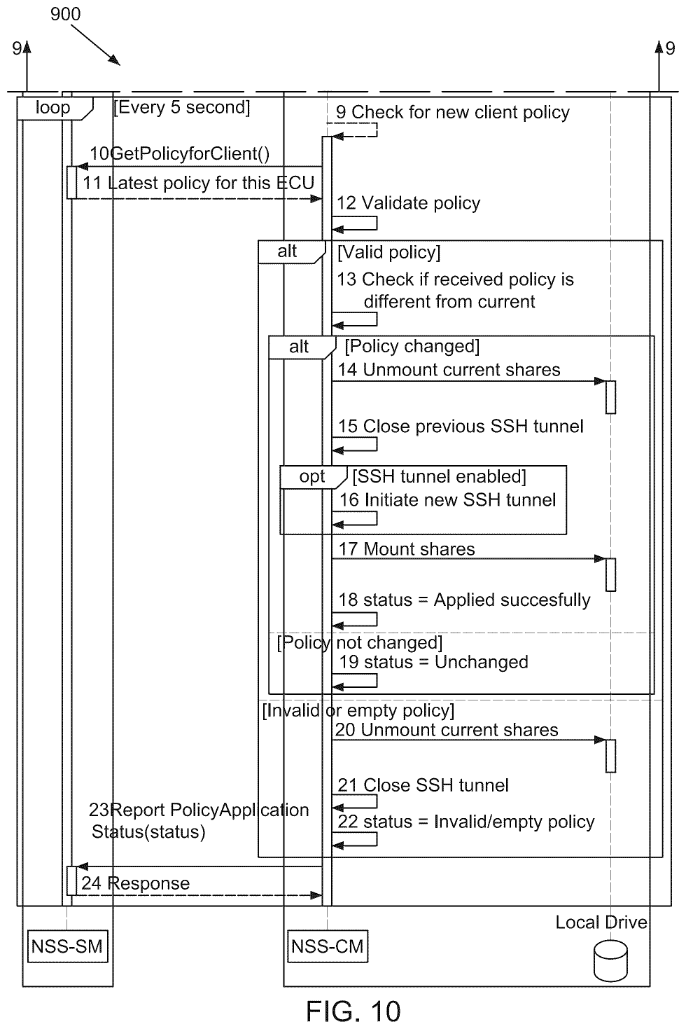

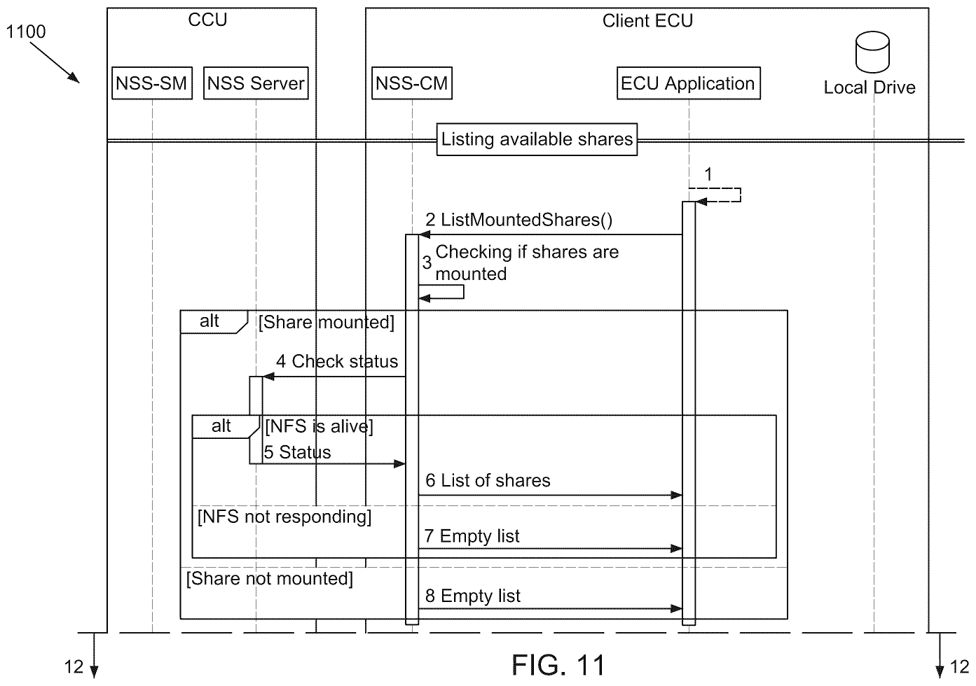

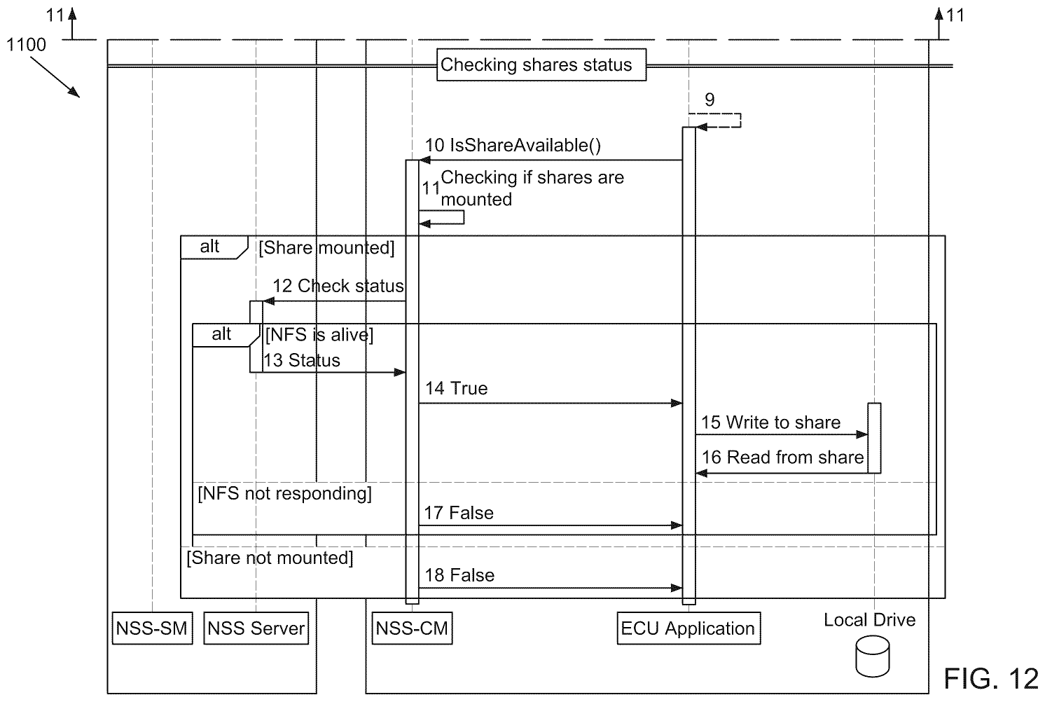

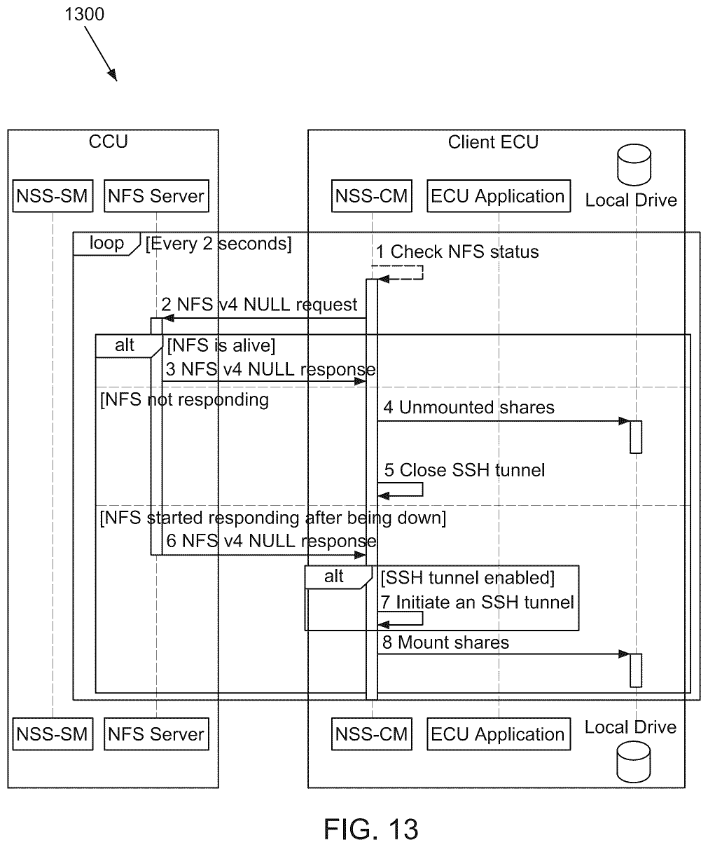

Referencing FIGS. 6A-6B, example on vehicle implementation of a policy is schematically depicted as a workflow 600. Referencing FIG. 7, an example policy implementation is schematically depicted as a workflow 700, with an external device operating a digital twin to monitor and confirm policy implementation is schematically depicted. Referencing FIG. 8, an example implementation 800 for shared storage operations in response to a shutdown event (e.g., where the vehicle operator has just turned the vehicle to an OFF operating state, such as when a keyswitch change to OFF has just occurred), including wind down operations to stop file sharing support and perform a rapid shutdown. Referencing FIGS. 9-10, an example implementation for operations to apply a policy through a shutdown and restart event is schematically depicted as a workflow 900. Referencing FIGS. 11-12, an example implementation for operations to begin shared storage operations after a startup of the vehicle is schematically depicted as a workflow 1100. Referencing FIG. 13, an example implementation 1300 of runtime for shared storage operations is schematically depicted. In certain embodiments, operations of FIG. 13, or other runtime operations, can include validating and implementing a non-invasive policy, such as a class C policy.

Embodiments herein provide for on-board network shared data storage 300 supporting entities 111 on a vehicle 101, where the entities 111 may each be an end point, a controller, a circuit, an application, a flow, or the like, as may be described by example herein. The example embodiments allow for adjusting the shared data storage operations utilizing a policy 220, which may be implemented as a simple file without any changes to baseline software operating on the vehicle.

Embodiments herein provide for management of shutdown operations as a part of the policy implementation system. Example embodiments to manage shutdown operations include operations such as: maintaining active and backup partitions; identifying policies by type and scheduling policy implementation according to the type; and/or managing shared storage operations during shutdown events. In certain embodiments, the policy implementation system includes management of startup operations. In certain embodiments, the policy implementation system includes storing or moving data between local storage (e.g., share entity storage 311 on a specific end point or controller), shared data storage 300 (e.g., the partition(s) utilized for shared data storage 300, which may be on/associated with the AP/CCU controller (e.g., the central storage 340) and/or distributed (e.g., across share entity storages 311), and external entity storage 330 (e.g., stored to the cloud, on a connected tool, etc.). In certain embodiments, movement between local/shared/external storage may be utilized to provide additional shared storage capability (e.g., utilizing cloud storage for slow cycle time accessed data), and/or to manage complex operating conditions such as rapid startup/shutdown sequencing (e.g., utilizing local storage until shared storage operations are available). Example embodiments herein include configuration of the shared data storage 300, for example utilizing different file systems, partitions, or the like, to support division of stored data in manageable size and/or to keep stored data typically associated with different policy classes segregated. An example embodiment includes providing for collection of statistics related to the shared data storage system for monitoring, analysis, and/or continuous improvement of shared data storage operations. An example embodiment includes saving state values (e.g., policy implementation values, shared storage entity access or operation values, etc.), for example to allow for management of the shared data storage system through vehicle startup and/or shutdown operations.

Example embodiments herein include full file organization for the shared storage, including providing for any file system and/or making more than one file system available, providing folders and/or directories for file storage, and providing compatibility with any file type for storage. Example embodiments include permissions scheduling and segregation (physical and/or logical) of data within the shared storage system. An example shared storage system includes providing the shared storage as a single large, high capability memory (that can be divided into logical partitions), and/or providing the shared storage as a distributed memory included on two or more end points and/or controllers on the system. Example permissions scheduling can be related to any entity or group in the system, and may include permissions for data access, data modification, data deletion, data lifecycle management (e.g., deleting old data, unneeded data, low priority data, and/or moving data to an external device), data access priority (e.g., allowing higher priority entities to preferentially read, write, and/or execute from the shared storage); and/or data resolution management (e.g., higher priority data may be stored on the vehicle 101 long term and in original or full resolution format, and/or in a lossless compression format or a low loss compression format; and lower priority data may be moved off vehicle (e.g., in an external entity 10 such as a cloud), summarized or aggregated, replaced with categorical or state based information, compressed in a lossy format, etc.). Data lifecycle management may include resolving data (e.g., moving it off vehicle, deleting it, compressing it, summarizing it, aggregating it, etc.) on a selected schedule, in response to certain events (e.g., a shared storage capacity threshold exceedance, a request from an external device, and/or a defined event of any type), and/or as determined heuristically (e.g., considering historical access and/or usage of the data or similar data) or by an expert system (e.g., according to rules set by the policy and/or set by an expert configuring the system).

An example embodiment includes division of implementation responsibility for the shared data storage system between a high level controller (e.g., the AP controller 110, CCU controller 109, SSH server, and/or NFS server) and low level controllers (e.g., an ECU controller, NSS client manager 150, and/or NFS client). Each low level controller manages client side shared storage operations for the end points, applications, flows, controllers, circuits, or the like for which it is assigned responsibility. In certain embodiments, a low level controller is embodied as a client manager on an ECU controller 120 that operates as an end point 113, with applications on that ECU controller 120 falling under the responsibility of the low level controller.

An example embodiment includes a policy based management of a shared data storage system, where the policy 220 defines one or more operating parameters for the system such as: network bandwidth management, storage management, permissions management, defined operation to off-nominal conditions (e.g., low storage capacity, loss of communication to one or more controllers or end points 113, rapid shutdown/startup events, limited network bandwidth, extended time periods where shared storage operations cannot be serviced for one or more end points, etc.), categorization of priority hierarchy (e.g., between end points 113 or shared data storage clients, where priority can relate to network utilization, shared storage utilization, processing utilization, etc.), and/or registration of entities or groups to categories for mutual consistent treatment for certain aspects of the shared data storage operations. Example and non-limiting priority schemes between messages of the shared data storage system may be implemented based on a message type (e.g., controls message, actuator request, A/V data, etc.), vehicle operating condition (e.g., cruise, high power operation, acceleration, network activity, startup/shutdown operations, etc.), message source (e.g., the sourcing end point, application, flow, group, entity, etc.), and/or message destination (e.g., the destination end point, application, flow, group, entity, etc.).

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems herein. The terms computer, computing device, processor, circuit, and/or server, (“computing device”) as utilized herein, should be understood broadly.

An example computing device includes a computer of any type, capable to access instructions stored in communication thereto such as upon a non-transient computer readable medium, whereupon the computer performs operations of the computing device upon executing the instructions. In certain embodiments, such instructions themselves comprise a computing device. Additionally or alternatively, a computing device may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware and/or computing devices include, without limitation, a general-purpose computer, a server, an embedded computer, a mobile device, a virtual machine, and/or an emulated computing device. A computing device may be a distributed resource included as an aspect of several devices, included as an interoperable set of resources to perform described functions of the computing device, such that the distributed resources function together to perform the operations of the computing device. In certain embodiments, each computing device may be on separate hardware, and/or one or more hardware devices may include aspects of more than one computing device, for example as separately executable instructions stored on the device, and/or as logically partitioned aspects of a set of executable instructions, with some aspects comprising a part of one of a first computing device, and some aspects comprising a part of another of the computing devices.

A computing device may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer-to-peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information (“receiving data”). Operations to receive data include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first receiving operation may be performed, and when communications are restored an updated receiving operation may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g., where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The methods and/or processes described above, and steps thereof, may be realized in hardware, program code, instructions, and/or programs or any combination of hardware and methods, program code, instructions, and/or programs suitable for a particular application. The hardware may include a dedicated computing device or specific computing device, a particular aspect or component of a specific computing device, and/or an arrangement of hardware components and/or logical circuits to perform one or more of the operations of a method and/or system. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above, and combinations thereof, may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer readable instructions described above. All such permutations and combinations are intended to fall within the scope of the present disclosure.

What is claimed is:

1. A system for providing shared data storage in a vehicle, comprising:
a plurality of network shared storage (NSS) client managers associated with a respective plurality of share entities in the vehicle; and
an NSS server manager communicatively coupled to the plurality of share entities and configured to manage access of the plurality of share entities to a shared data storage,
wherein the NSS server manager is further configured to manage access of the plurality of share entities by configuring at least one of the plurality of NSS client managers to manage access to the shared data storage of an associated one of the respective plurality of share entities,
wherein the NSS server manager is communicatively coupled to the plurality of share entities over a mixed in-vehicle network (IVN) including a plurality of different network types.

2. The system of claim 1, wherein the plurality of different network types includes a Controller Area Network (CAN) based network and an Ethernet based network.

3. The system of claim 2, wherein the IVN includes a configurable edge gateway (CEG) configured to access the CAN based network and an Ethernet switch configured to access the Ethernet based network.

4. The system of claim 2, wherein the NSS server manager is configured to facilitate communications between the plurality of different network types.

5. The system of claim 2, wherein the NSS server manager is configured to:
capture an initial Ethernet message from one of the plurality of share entities on the Ethernet based network;
convert the initial Ethernet message to compliant CAN message information; and
package the compliant CAN message information into an Ethernet message to store the compliant CAN message information in the shared data storage.

6. The system of claim 5, wherein the compliant CAN message information includes information to build a compliant CAN message.

7. The system of claim 5, wherein the compliant CAN message information includes a compliant CAN message.

8. The system of claim 5, wherein the NSS server manager is further configured to:
upon request from a requesting entity, unpackage the compliant CAN message information from the shared data storage and provide the compliant CAN message information to the requesting entity.

9. The system of claim 2, wherein the NSS server manager is configured to receive a CAN message from the CAN based network, and package the CAN message into an Ethernet message for storing in the shared data storage.

10. The system of claim 9, wherein the NSS server manager processes the CAN message according to at least one of a sampling rate, a resolution, or units associated with the CAN message and packages the CAN message with information regarding the at least one of the sampling rate, the resolution, or the units.

11. The system of claim 2, wherein the plurality of different network types includes a Controller Area Network (CAN) based network, and the plurality of share entities includes a CAN electronic control unit (ECU) with a respective one of the plurality of NSS client managers associated therewith, the respective one of the plurality of NSS client managers communicating with the NSS server manager on behalf of the CAN ECU over the CAN based network.

12. The system of claim 11, further comprising:
the respective one of the plurality of NSS client managers configured to interpret communications between the CAN ECU and the NSS server manager, the plurality of share entities, and the shared data storage.

13. The system of claim 1, wherein the NSS server manager manages data from the plurality of share entities according to a data policy that specifies moving the data from a first portion of the shared data storage to a second portion of the shared data storage over a lifetime of the data.

14. The system of claim 1, wherein the NSS server manager manages data from the plurality of share entities according to a data policy that includes a redundancy description that specifies types of data to be stored redundantly.

15. The system of claim 14, wherein the redundancy description indicates a first type of data to be stored in a physically redundant manner, and the first type of data is critical data.

16. The system of claim 15, wherein the redundancy description indicates a second type of data to be stored to provide control redundancy, the second type of data accessible by a plurality of electronic control units (ECUs).

17. The system of claim 15, wherein the redundancy description indicates a specific location of the shared data storage to store the first type of data in the physically redundant manner.

18. The system of claim 16, wherein the specific location of the shared data storage is at a different end point than a first location of the shared data storage at which the first type of data is stored.

19. The system of claim 1, wherein the IVN includes a configurable edge gateway (CEG), and the NSS server manager is configured to instruct the CEG to route data between the plurality of different network types according to at least one of a priority, a utilization, an operating condition, or a current storage status of the shared data storage.

20. The system of claim 1, wherein the mixed IVN includes a network switch and the shared data storage is behind the network switch relative to the plurality of share entities, and the NSS server manager is further configured to manage access of the plurality of share entities to the shared data storage by controlling bandwidth usage of the plurality of share entities at the network switch.

21. The system of claim 1, wherein the plurality of share entities includes a plurality of end points of the vehicle.

22. The system of claim 21, wherein the plurality of end points includes at least one of an electronic control unit (ECU), a controller, a smart sensor, or a smart actuator.

23. The system of claim 21, wherein the plurality of end points includes at least one of an application or a flow distributed across multiple ones of the plurality of end points and managed by an NSS client manager associated with the at least one of the application or the flow.
